(19) United States
(12) Patent Application Publication
(10) Pub. No.: US 2008/0166693 A1
(43) Pub. Date: Jul. 10, 2008

(54) Method and system for optimal learning

(76) Inventors: Warren Stanton Gifford, Long Branch, NJ (US); Richard Alen Robbins, New York, NY (US); Mojahdui Hoque Abul Hasanat, Block E. Banani (BD); Syed Muhammad Sazzad, Alpharetta, GA (US); Justin Mark Brockie, Wolcott, CT (US); James Michael Kelly, Woodbury, CT (US); Ziaur Rahman, Gulshan 2 (BD)

Correspondence Address: Milbank, Tweed, Hadley & McCloy LLP, 1 Chase Manhattan Plaza, New York, NY, 10005-1413, US

(21) Appl. No.: 11/986,912

(22) Filed: Nov. 27, 2007

Related U.S. Application Data
(60) Provisional application No. 60/861,165, filed on Nov. 27, 2006.

(51) Int. Cl. G09B 7/00

(52) U.S. Cl. 434/322

(57) ABSTRACT

In a method and system for gathering, organizing, and managing all information relating to Learning processes, a computerized system may receive and store Learning information from individuals. Individuals may have the ability to update the information as needed. This information may be organized and monitored. Access to the Learning information may be granted to authorized users. Embodiments of the invention may also receive Learning Requirements which may be Requirements imposed on individuals by various governing bodies, such as national, State, local and institutional bodies. Embodiments of the invention may organize, monitor and store the Requirements and provide access to the Learning Requirements to authorized users. Embodiments of the invention may also receive and store Learning Resources and Testing Resources. Embodiments of the invention may also cross reference the Learning information, the Learning Requirements, the Learning Resources, and the Testing Resources, while accounting for the various privacy requirements.

### CROSS-REFERENCE TO RELATED PATENT APPLICATIONS

This patent claims priority pursuant to 35 U.S.C. § 119(e)(1) to U.S. Provisional Patent Application Ser. No. 60/861,165 filed Nov. 27, 2006 and incorporates by reference its entire disclosure herein. The entire disclosure of U.S. patent application Ser. No. 11/604,577 filed Nov. 27, 2006 is incorporated by reference herein.

### FIELD

Embodiments of this invention relate to methods for creating, implementing and managing optimal learning programs. For many jobs there may be a complex array of information, such as knowledge and skills, which the Learner may need to know and to be certified. This information, knowledge and skills may need to be gained in order to satisfy requirements of the state, the agency, or even the individual a person may be serving. Thus, managing and improving the Learning Process may be an important aspect for Learners to perform their job efficiently and effectively, and for the organization to manage its compliance with policies and regulations. Embodiments of the invention provide a system that determines, among other things, what may be needed to be learned, evaluates the many options for learning it, manages the implementation of the overall plan of learning, and tracks the results. The information on the different aspects of the Learning Process may be potentially useful to all the people and organizations involved, including those who set requirements, those who develop learning organization policies, the Learners, those managing a learning organization, and those providing Learning Resources. Embodiments of the invention may provide mechanisms to support all these different users, including the privacy requirements.

### BACKGROUND

In many fields the Learner may be requested to be familiar with multiple skills, and may need to have certification. For example, there may be Learners working in hospitals, or other medical institutions, who had been selected for their assigned job depending on their educational qualifications. Jobs in such institutions may require not only the academic education but trainings that include practical instructions—and monitoring in real life situations. The Learner may be expected to meet the standards set, for example, by: international, national, state, and local governments, professional, technical, and other associations, schools and colleges, and employers. The Learner may need training in various subjects to be fully eligible to start and perform the assigned job effectively. They may even need to complete the assigned or required training within a specified time depending on the requirements of their assigned job.

There may be many different ways to acquire such skills and knowledge. A Learner may be trained at a school, by their employer, by computer-based training, over the Internet, or a wide variety of other training alternatives. The processes of determining what needs to be learned, how best to select among the many options for learning it, and carrying out the overall plan of learning may be challenging.

The challenges may apply to both an individual Learner, and to an organization to meet its own requirements and to guide its members through the process. This may involve complex policies, practices, and purchases as major ongoing efforts requiring considerable time and skills, and the knowledge must be kept up to date.

For example, a person providing supports to Individuals with Developmental Disabilities (DD) may be subject to a wide variety of requirements for skills and knowledge; specified by government agencies, by the organizations coordinating the support, by the specific needs of the Individuals supported, and by events and other circumstances. Often, the certification for a new person must be completed within a certain period of time, and the different skills must be recertified on a specified schedule.

Determining what needs to be learned and how best to accomplish the learning, including tracking often may require significant management resources to, among other things, schedule classes, collect the information on certification from instructors, administer tests, and keep up with all the changes in requirements, staff, and course content. Also, an organization might need to determine how best to implement the requirements placed on it and its members. For example, the organization may need to determine if it should have its own members serve as instructors, if it should send its members to classes elsewhere, or if it should purchase training in some of the wide array of forms such as books, videotapes, and online learning services among others. The entire process of learning may request collection, analysis, and management of resources from different sources.

Once the Learners have completed the training, their results may need to be tested and certified. It may be essential to store and manage these results as they may later be considered as requirements for other future trainings.

Currently training institutions or Learners store and manage their results manually and separately. Alternatively, they may be maintained in simple computer programs, such as popular spreadsheet programs, which merely track information and do not assist in the selection, delivery and certification processes. For Optimal Learning Process, the preferred embodiment may allow the storage and management of resources to be performed in a way that all the relevant information may be accessed by the authorized user any time anywhere. The preferred embodiment of this invention may address all of these areas by providing, among other things, a system and methods for gathering and managing the needed information; formulating, evaluating, and optimizing the process of selecting and learning; and supporting and tracking results and certifications.

### BRIEF DESCRIPTION OF THE DRAWINGS

FIG. 1 illustrates the overview of an implementation of the Optimal Learning System.

FIG. 2 illustrates the Resource Access and Management Process.

FIG. 2a illustrates a sample of notification sent out when a sign up has been made for a resource.

FIG. 3 illustrates an example of Requirements and Goals.

FIG. 3a illustrates a sample of a specification of a Requirement.

FIG. 3b illustrates a sample of the Invention for specifying Provider Requirements for Abuse and Neglect.

FIG. 3c illustrates a sample of the Invention for Assignment of Provider Requirements for Abuse and Neglect to Learners.

FIG. 3d illustrates a sample of an embodiment of the Invention that allows for the management of resources.

FIG. 4 illustrates the Abuse and Neglect examples of Requirements and Goals

FIG. 4a illustrates a sample of the Invention for specifying Provider Requirements for Abuse and Neglect.

FIG. 5 illustrates Alternative Relationships between Resources and an embodiment of the invention

FIG. 6 illustrates the Monitoring Use of Resources

FIG. 7 illustrates examples of Certificates Corresponding to Requirements and Goals

FIG. 7a illustrates a sample of the Invention where Instructors' Certification Report may be viewed.

FIG. 8 illustrates an Optimal Learning and Certification Process

FIG. 8a illustrates a sample of the Invention where Reports on Training Hours may be created to assist in the overall Learning and Certification Process.

FIG. 9 illustrates Resources and Certificates in a Sample Learner Plan for an Abuse and Neglect example

FIG. 9a illustrates a sample of the Invention where Current Certifications of a Learner may be entered into embodiments of the invention.

FIG. 9b shows a sample of the Invention that may be used to enter Past Certifications for Different Learners

FIG. 9c illustrates a sample of Certification Results that may be Published using embodiments of the invention.

FIG. 10 illustrates Evaluation and Optimization for Learning Decision Making—Comparing Actual with Predicted Ratings for One Learner

FIG. 11 illustrates Evaluation and Optimization for Learning Decision Making—Predicting E-Cubed Ratings

FIG. 12 illustrates Evaluation and Optimization for Learning Decision Making—Finding Learners with similar Models

FIG. 13 illustrates Evaluation and Optimization for Learning Decision Making

### DESCRIPTION OF THE PREFERRED EMBODIMENTS

The preferred embodiments of the present invention may provide a system comprising of methods for gathering and managing the information needed for learning in an integrated secure environment that enables the Learner and related people and organizations to formulate, evaluate, optimize, and manage the overall learning process. These embodiments may have mechanisms to arrange information about all the aspects of the learning in consistent models and provide appropriate access to the information so that it may be used across all the different requirements and resources to achieve the objectives of each specific Learner or learning organization. These embodiments may provide mechanisms to support all the people and organizations involved in the learning process, including those who set requirements and those who develop policies.

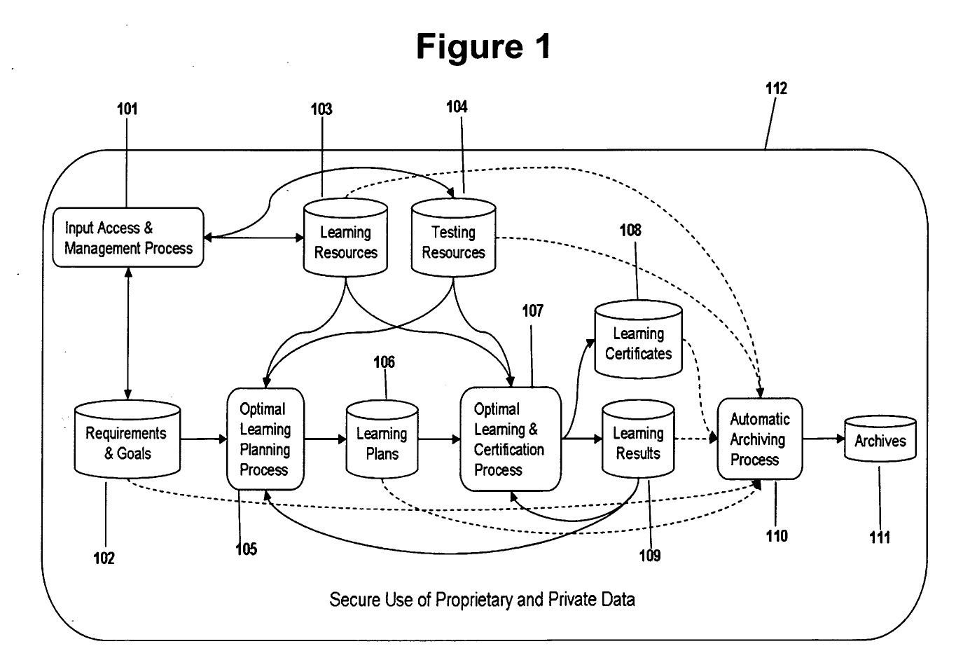

As shown in FIG. 1, an embodiment of the invention may provide a system that includes methods for gathering and managing all the information and activities associated with the Learning Process. The Input Access and Management Process 101 may ensure that authorized users may enter and access information and update the information when necessary. The information may include Requirements from the organization, state or other authorized institutions for the Learner to be able to perform the assigned tasks efficiently and effectively, as well as Goals set by the Learner. These Requirements & Goals 102 may be stored in embodiments of the invention. This embodiment of the invention may provide mechanisms that use Requirements and Goals to develop Optimal Learning Plans. Learning and Testing Resources may also be evaluated as part of developing the Learning Plans in the process of optimal learning and certification.

Learning Resources 103 may be the content and mechanisms used to help learn specific material. They may come from many different sources and in a wide variety of formats. Learning resources may be created, used, and managed by a variety of different users, and embodiments of the invention may provide the mechanisms for these users to have accounts with defined roles and abilities so they may interact with embodiments of the invention and the information in appropriate ways.

Testing Resources 104 may be the content and mechanisms to verify eligibility of users based on different requirements. Embodiments of the invention may have mechanisms to design each Testing Resource for interaction with the user to determine whether they have learned something. These embodiments may also allow for mechanisms to compare with a Learning Resource to assure that it may be appropriate for the Learner to continue. Embodiments of the invention may enable users to specify criteria for successful completion of a Testing Resource. Successful completion of one or more Testing Resources may result in learning certifications for the Learner.

Embodiments of the invention may provide an Optimal Learning Planning Process 105 that may combine the Requirements and Goals along with the Learning and Testing Resources to come up with optimal Learning Plans 106. A Learning Plan may include the set of actions and resources which may be used to achieve a set of objectives. Examples of Learning Plans may include Learning and Testing Resources, and other activities a Learner may use to be certified in a particular skill. It may also include the plan for an entire organization to meet the Requirements for a whole job classification, including organization policies, schedules, and procedures, the Learning Resources the organization may purchase or subscribe to, the instructors and other staff to assign, scheduling of classes and other activities, and the methods of testing and certifying each person in that job category. A Learning Plan may also come from a state organization that establishes the list of skill Requirements, the requirements for certification and recertification, the Learning Resources that may be used, and purchases or subscriptions to Learning Resources at the state level.

Embodiments of the invention may provide specific algorithms for rendering the information anonymous, aggregating it, and extracting exactly what may be needed by a Learner or learning organization to help them determine their optimal Learning Plans. These plans may be stored in embodiments of the invention for future reference. Embodiments of the invention may also support monitoring and updating the plans as changes occur in the information.

With the Optimal Learning Plan, embodiments of the invention may have an Optimal Leaning and Certification Process 107 to implement the plan, provide certification that the learning has been successfully completed, and gather the data generated by using embodiments of the invention to update the information used in evaluating and planning. Once the Learners have completed a phase of the learning process, the Learning Certificates 108 and Learning Results 109 may be recorded and stored in embodiments of the invention in a secure environment. A preferred embodiment of the Optimal Learning Process may depend on use of detailed results of learning both by a Learner and other users of embodiments of the invention; thus, a preferred embodiment of the invention may have the ability to record the various Learning Results so that they may be used by other Learners in the process.

Learners may be provided certificates on the basis of the results obtained. This may certify that a Learner or learning organization has met specific Requirements and Goals. Embodiments of the invention may also include the concept of chain of Learning Certificates which may verify that a whole set of dependent Learning Certificates was valid when a particular Learning Certificate was issued.

Embodiments of the invention may provide an Automatic Archiving Process 110 that may allow secure storage of the information in an archive. The Archive 111 may also include appropriate versions of the Learning and Testing Resources, as these may also be modified depending on the Requirements of the source of inputs—organization, state, or academic organizations. Archiving may enhance the method of tracking Learners' records and updates of the courses' Requirements and Goals. It may help the Learners and organizations acting as training institutions to review the cause and circumstances of the changes for future use. Data archives may be provided by embodiments of the invention to track the version and the history of changes to information. Thus, even when a learning resource may be changed by its owner, the version used by the Learner may be retained.

### Secure Use of Proprietary and Private Data for Optimal Learning

Some information used in the Optimal Learning Process may be private or proprietary, so embodiments of the invention may provide mechanisms to assure that a person or organization may specify what may be shared, and with whom, and that the terms of use may be met, along with the costs and other conditions of using the information, as well as the balanced sharing of mutually beneficial information. In particular, often, only summary information may be shared, not the full details, and the methods may allow specification of precisely which algorithms may be allowed for sharing what information and with whom.

Data ownership and management responsibility may be defined in embodiments of the invention, including which users may be authorized to make changes to the various data. Embodiments of this system may ensure that Individual information may be securely stored, eliminating the risk of loss of information. These embodiments may allow users to record information to a database making the information securely available any time, anywhere to users who have authorization to access the information, including special provisions for emergencies. Users in different security domains may access information and perform actions depending on the roles and privileges assigned by the administrators in all the relevant security domains.

Embodiments of the invention in this document may provide ways of sharing private health information and ensuring a means to restrict any unauthorized access or sharing of such information across different security domains, so that each security manager may be responsible for users in their own domain, and yet may specify the level of access for users in other domains.

Accomplishing this may involve algorithms to assure that any sharing may be appropriately authorized, that Learners or users may be correctly matched among security domains, that emergency access may be provided appropriately, that archived information may be appropriately managed, and that all accesses and changes may be tracked in accordance with security requirements.

Embodiments of this invention may also include systems allowing users in one organization to access information under different security domains within that same organization. Such a system for augmenting prior art security management arrangements may be referred to as “Caseloads,” which may allow the security manager to define access protocols and, thus, may specify the access capabilities of the user. A conventional program-based security access system has a user who may be assigned privileges for different programs within an organization.

Data characteristics may be provided by embodiments of the invention to assist in managing security and access, for example, the date information was changed.

### Need for Basic Privacy and HIPAA Privacy

Embodiments of the invention may relate to managing secure sharing of private information across security domains. This may be widely applicable, and may be requested by healthcare applications to comply with Health Insurance Portability and Accountability Act of 1996 (“HIPAA”)—a set of standards and requirements for the electronic transmission of certain health information implemented to increase the efficiency and effectiveness of the health care system; this may be particularly challenging for Individuals with Developmental Disabilities (DD). Embodiments of the invention may also be applicable with respect to other regulations—for example, financial services regulations—as well as other laws, standards, and policies—for example, proprietary information for different portions of a project. Preferred embodiments of this invention may include the ability to share information among authorized users across different organizations and security domains, without requiring direct contact among security administrators in different domains, and yet still complying with security requirements.

Some currently-available applications requiring privacy or security of electronic information, may use rule-based security access, with a variety of recognition systems for each user. Such applications may not include a system for maintaining the security of information when it may be electronically shared among different security domains, which may be disadvantageous.

Typically, information may be shared securely among organizations in paper format because of a lack of compatible electronic formats and appropriate privacy and security systems. The desired information may be physically copied and delivered. This makes it prone to delays, missing information, unregistered users, and questions of what information may be authorized to be transmitted and unauthorized access by different people. All these may be challenges with the current physical system in complying with security protocols.

The HIPAA regulations may include rule-based security systems as the target practice. These systems may be widely used throughout the government and industry. However they may address how to actively share information across security domains managed separately. In many hospitals, the combination of being unable to predict who may need to provide care, especially in an emergency, and the challenges of maintaining a variety of accounts and passwords, each with limited access, results in each doctor and health professional being provided with access to all patients' information throughout the institution. These practices may expose healthcare providers to potential liability for not properly protecting sensitive Individual health information.

This may be particularly challenging for Individuals with Developmental Disabilities (DD), which may be lifelong conditions with varying degrees of impairments. Individuals may be often subject to more medical and other health conditions, and may have more emergencies. They may have others designated to act on their behalf in various capacities including medical, financial, and legal. Access to Personal Health Information (“PHI”) about health and related conditions may be strictly regulated by HIPAA and other state and federal regulations, which complicates providing support and services.

Care and support for Individuals with Developmental Disabilities (DD) may be often distributed among many people and organizations, including parents, service providers, doctors and other health professionals, volunteers, and case managers and others appointed by various funding and regulatory jurisdictions. The responsibilities and privileges of different users (ranging from parents or guardians to health care professionals and staff members) may differ by funding sources and organizational structures, and thus a flexible system for determining who has access to what information may be essential. For example, often an organization providing support to an Individual may have different groups with separate staff to provide different functions, and thus processes may be used to control who has access to what information by application and Individual; also a staff member with specialized capabilities, such as a behaviorist, has responsibilities that cut across other organizational boundaries and serve one or a few Individuals out of each grouping.

Individuals often change the organizations which provide support for them and thus users wish to be provided access to appropriate information covering past conditions and situations from other organizations. HIPAA and other regulations request that Individuals and their agents be able to update their PHI records. Changes in information may need to be shared and maintained among a range of people and authorities over many decades.

In the face of such challenges it becomes difficult for care providers to manage privacy and security of information and communications about the Individuals they serve, particularly in accordance with HIPAA regulations. Such limitations urgently call for a system that may facilitate secure entry, access, sharing, updating, storage, and management of information about an Individual.

Similar situations exist in many other industries. Banking and credit companies may be examples of where many different organizations use and create information about people with a critical need for security and privacy. Proprietary information within and among organizations regarding product development, marketing, sales, and other areas of operations also benefit from such a system.

### Sharing of Data Based on Authorizations Including Specification of Algorithms

A Learner may record detailed information about their use and rating of resources or any other learning related information. This information may be useful as part of predicting and evaluating other Learners ratings for that particular learning resource. In this case, for example, the second Learner should not be able to use or see the detailed information about the first Learner, but should be able to use suitable generalized versions of the first user's ratings, for example, combined with many other users so that it may be no longer traceable to the first Learner. This may be an example of explicitly authorizing specific algorithms for sharing information.

Access and use of algorithms may be preferred embodiments of the invention due to the need to share information while maintaining privacy and security. The reasons and conditions for the sharing may be varied, and thus embodiments of the invention may need to accommodate a wide variety of algorithms. For example, many situations may be specified by law so algorithms may be defined to implement those, for example, Private Health Information (PHI) and its conditions of user may be explicitly defined in the HIPAA (Health Information Portability Act) laws; other laws apply to employee rights and employer responsibilities regarding employee information.

Other situations may be specified by organization policies and procedures, for example, what information a prospective employee may need to provide on a job application and the requirements for hiring a person. An organization might request that any employee driving on company business has fewer than 5 points on their driver's license due to insurance limitations, so the employee may need to disclose that information to be able to drive on company business.

The Learner may have control over access to much of the information about their learning experiences, subject to legal and valid organization policies and practices. For example, the Learner may need to sign a release for a school transcript, in accordance with applicable laws; however, if the employer provides a course internally they may automatically have rights to the results.

Embodiments of this invention may comprise the sharing among many Learners and organizations of detailed information on each of their use of Learning Resources. The details of this information may be highly private and governed by various laws. However, these embodiments of the invention may provide specific algorithms for rendering the information anonymous, aggregating it, and extracting exactly what may be needed by a Learner or learning organization to help them determine their Optimal Learning Plans. An embodiment of the invention may comprise the use of “shared mutual benefit”, so a Learner or organization may allow others to use their data with specific algorithms if they, in turn, may use the corresponding information from the receiver. Embodiments of the invention may comprise versions of the algorithms that may provide additional flexibility in specifying terms of use.

Embodiments of the invention may have mechanisms that implement the authorized sharing, use, and management of data by running the appropriate algorithm on the appropriate data and presenting the results. These embodiments may also track the use and changes in authorizations.

The following may be examples of algorithms for sharing information: a user may authorize a particular “standard” algorithm, and then when the standard algorithm changes, the user may choose whether their authorization may be automatically upgraded to the new standard, or they may be notified of the change and may then extend the authorization or modify it. They may wait to be notified until someone requests use of the authorization, and then the user may be notified of the change in the standard and the request to exercise the authorization, so the user may not be bothered by every change if it may not be used. The user may choose what happens with each authorization. There may be either a one time use of the authorization, the user may be notified each time the authorization may be used or the user may be notified before the request may be granted so they may select whether to grant the authorization or block it.

Particular users or groups of users may be identified for special treatment, for example, they may be blocked from receiving authorizations, may require the user's explicit permission each time they want to use the authorization, or they may have a one-time-only authorization. Users and groups may be defined externally, for example, as employees of a particular company.

Authorizations may be managed as classes, so that each one may not need to be addressed by the user separately. Authorization algorithms may be used to determine who has paid for a Learning Resource, Testing Resource, or even Requirements and Goals. Detailed standards may be often charged for and authorization algorithms may comprise a wide variety of mechanisms. For example, an individual Learner may purchase a single resource or a package of resources. This may correspond to use for a period of time, certain number of accesses, or other measures of the user for that resource. The charge could correspond to the amount of use, or could provide options to the user as they use more and more of the resource.

A learning organization may purchase access for its members, for example, an employer purchasing rights to a set of resources for all or a subset of its employees, again, with a variety of limitations on use.

A state organization may purchase full or partial rights to access for organizations it regulates, or for individual users within that group where the pricing could also include additional payments from the corresponding organizations or individuals.

Other organizations may purchase rights for their members. For example, a state provider association may purchase rights for its entire member organizations. The tracking of Certificates which may be described in the optimal learning and certification process may be an important input to these pricing algorithms.

The following may be an example of Abuse and Neglect training: Abuse and Neglect training often may include significant proprietary and private information.

The fact that a staff member received Abuse and Neglect training out of the normal cycle of certification may be information private to the Learner, because it may be inferred that the Learner was involved in an Abuse and Neglect allegation merely because they receive this training, whereas they might have been completely uninvolved in any incident, and just happen to work at the same worksite that an incident took place.

The identity of the individual who may be the alleged victim of Abuse and Neglect may be very private information to that individual and needs to be guarded separately from information about training of staff members supporting the individual.

The fact that Abuse and Neglect training was provided outside of the normal cycle may be proprietary information to an organization because it may be inferred to indicate the level of allegations of Abuse and Neglect.

Sample algorithms may involve a Learners Transcript, HIPAA Security, as well as employment applications. For example, a complex pricing algorithm for a learning service, which includes an economy of scale and thus has different pricing for individual users, providers depending on their size, and entire states, along with an organization purchasing partial rights which may require additional payments by members or individual users.

### Chains of Certificates

A Chain of Certificates may be when the validity of one certificate depends on the validity of one or more others. An example of this may be that a Direct Support Professional (DSP) may be certified to pass medications only under the license of the registered nurse. Thus, if the registered nurse's certificate has expired, even though the DSP's certificate has not expired, the DSP may not be allowed to pass medications.

Certificates may be the mechanism for allowing a particular user to access specified information using specified algorithms.

In some cases a Certificate may be very explicit from an Individual, such as a signed document authorizing a transcript from a college to an organization. In other cases, the Certificate may be implicit, such as a law enforcement official who checks a person's driving records (by obtaining a driver's license you implicitly agreed to the laws governing access of information); while others may be a hybrid, such as, by becoming an employee of an organization one permits that organization access to collect and use a wide variety of information in the learning system.

Embodiments of the invention comprise providing mechanisms to determine which specific users may be covered by a specific certificate.

Certificates may be required for various users who may be involved to verify the identity of these users i.e., the users may be who they actually say they may be. There may be a Chain of Certificates for those certifying the individuals.

### Resource and Access Management Process

As Requirements and Goals may be changed, version control may be provided to determine which version applied at a particular time.

For example, if the state changes the Requirements for Abuse and Neglect, a plurality of the providers and Learners who may be subject to those changes may need to change their Learning Plans, and update their training and certifications. The person managing Requirements for the provider may need to be aware that the state has changed Requirements for Abuse and Neglect, and, thus. needs to change the provider training Requirements. A change may include a date when the change takes effect, and when Learners need to be receiving training, and a date when previously certified Learners must receive updated training. Based on these changes, the provider may need to update the Learning Resources they control or select different Learning Resources, or notify the owners of Learning Resources that changes may be required, along with the new Requirements.

Changes in Requirements may also dictate changes in testing resources and Learning Certificates, either differences in Learning Certificates issued after the new requirements take effect, or additional Learning Certificates based on retraining of previously certified Learners.

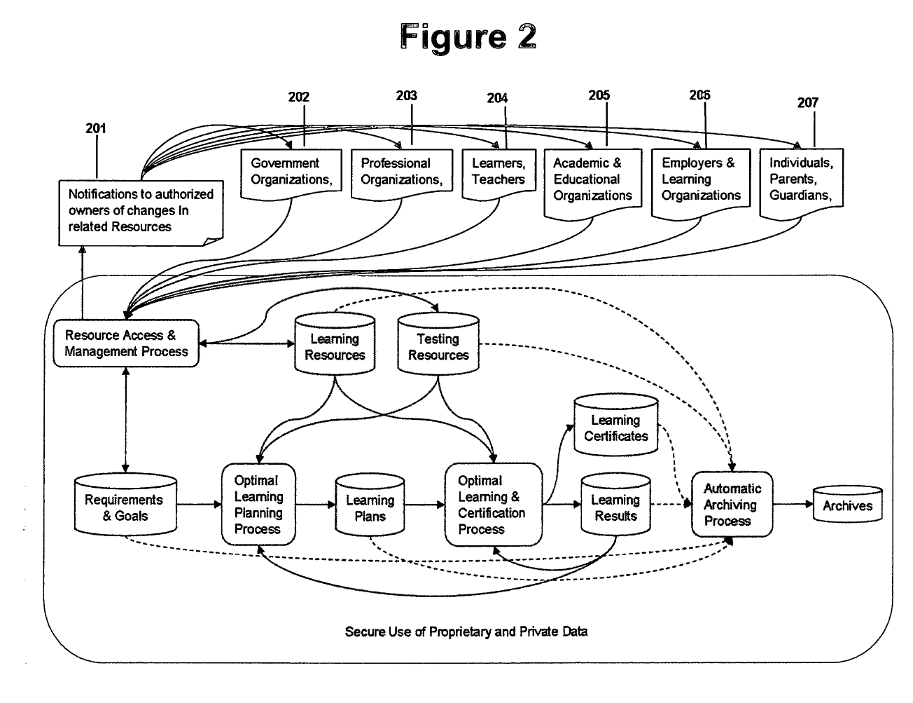

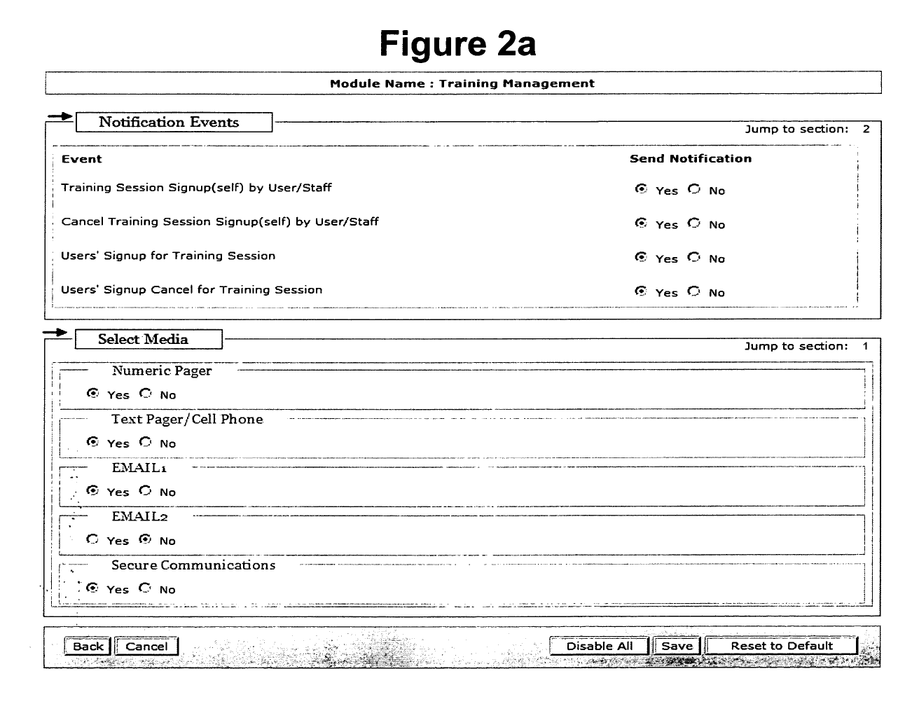

FIG. 2 shows an overview of how a resource may be accessed and managed through embodiments of the invention. Embodiments of the invention may allow for a variety of different organizations and individuals who may manage the various types of information which may be inputs to the Optimal Learning Process. The various organizations may comprise Government Organizations 202, Professional Organizations 203, Learners and Teachers 204, Academic and Educational Organizations 205, Employers and Learning Organizations 206, and Individuals, Parent, and Guardians 207. Embodiments of the invention provide a flexible mechanism for entering and managing the external inputs to the Optimal Learning Process. The inputs made by different people may be the same or similar requirements from different perspectives. Embodiments of the invention have mechanisms to keep track of which perspective may be being addressed by a particular user. The information may be changed; therefore, there may be mechanisms to ensure version control and to determine which version applied at a particular time. There may also be mechanisms to ensure that the authorized users receive appropriate notifications when changes may be made to related resources.

FIG. 2a illustrates a sample screenshot of a typical notification sent out when a Learner signs up or cancels their subscription that has been made for a particular Resource. As shown in FIG. 2a, embodiments of the invention may comprise methods to send notifications to authorized users when a sign up has been made for a resource or when a sign up has been cancelled. Embodiments of the invention may also comprise sending notification to a number of media, for example, numeric pager, text pager, and e-mail among others. The notification profile may be personalized for authorized users, so that they may receive notifications on one or more instances of Learner sign up or cancellation.

### Requirements and Goals

Embodiments of the invention may have mechanisms to collect and integrate formal and informal Requirements and Goals from a variety of sources to assist in creating a consistent set of measurable objectives. Embodiments of the invention may provide the Learner access to a plurality of the Requirements and Goals through one interface, thus, enhancing and simplifying the learning process.

Learning Requirements and Goals may come from many different sources and take many different forms, and these embodiments may provide consistent methods for recording, applying, and managing them, which may include defining their authenticity and applicability. Part of the complexity may be that many different people may be authorized to input the same, or similar, requirements from different perspectives, and embodiments of the invention may keep track of which perspective may be being addressed by a particular user.

Learning requirements may be determined as a dynamic combination of varied inputs and factors as described below:

General requirements: This may include standards set by international, national, state, and local governments, for example, specific job requirements for a Direct Support Professional (DSP) for people with Developmental Disabilities (DD). It may also include standards set by Individuals, Parents, Guardians, and Academic Institutions, for example, degree or course requirements. Requirements may also comprise standards set by Professional, Technical, and other Associations, for example, requirements of a Nurse, Engineer, Doctor, Lawyer, and Pharmacists. There may be standards set by Commercial Entities and Employers for job characteristics. Individuals, Parents, and Guardians may define specific requirements, for example, special medical requirements or notification requirements in case of an allegation of Abuse and Neglect.

Time dependent factors: Time dependent factors may include certification validity, for example many skill certifications may be valid for only a certain period of time, after which they must be renewed either with the same or a different course of study. Another example may be where CPR must be renewed annually or different courses must be taken to broaden the skills over time. Requirements may also change after a certain time, and that requires Learners to acquire additional skills before a certain time.

Situation specific requirements: Skills may be required based on certain situations, such as skills required for tasks not typical for the job. For example, an individual may exhibit sudden behaviors for which the Learner must acquire additional skills. There may also be skills needed for remediation for specific incidents or other situations the Learner may be involved with: a Learner may need special training for special or unusual events.

Requirements and Goals may be represented in a variety of forms by embodiments of the invention. Many different users and types of users may input and manage Requirements and Goals. The Optimal Learning Process may allow Learners and learning organizations to select the appropriate Requirements and Goals that may apply to their specific situations. A Learner may be requested to meet the Requirements and Goals set by different authorized organizations. Requirements may take the form of detailed regulations which may include the following: Long Documents, Overlapping Documents, and Documents with only a portion relating to the subject at hand, for example, federal and state laws applying to a particular situation.

The different authorized organizations, directly or indirectly, may influence each other, the Learner, and the entire Optimal Learning Process. The training that the Learner may be requested to take may be decided on the basis of the learning requirements matched with his/her assigned job.

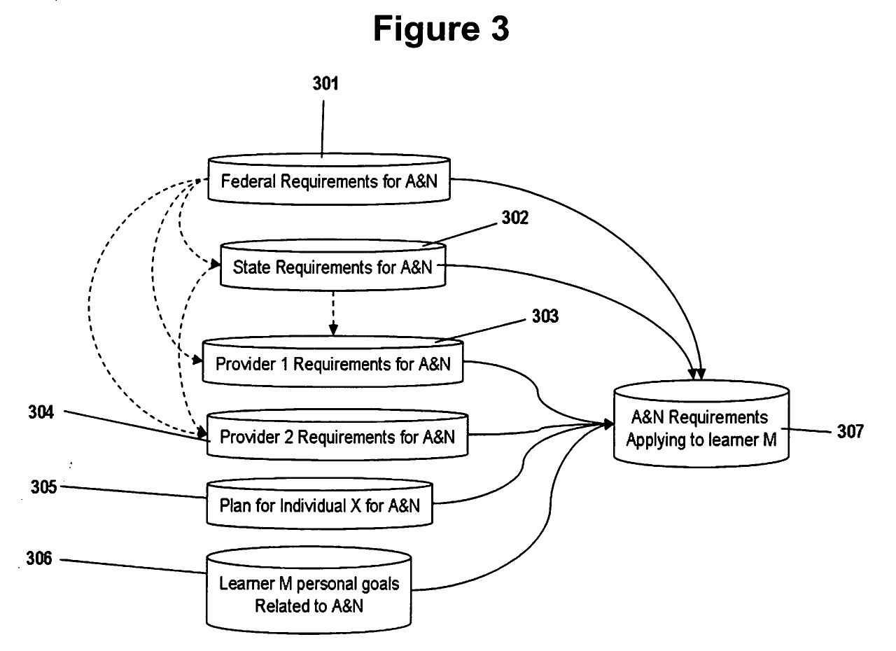

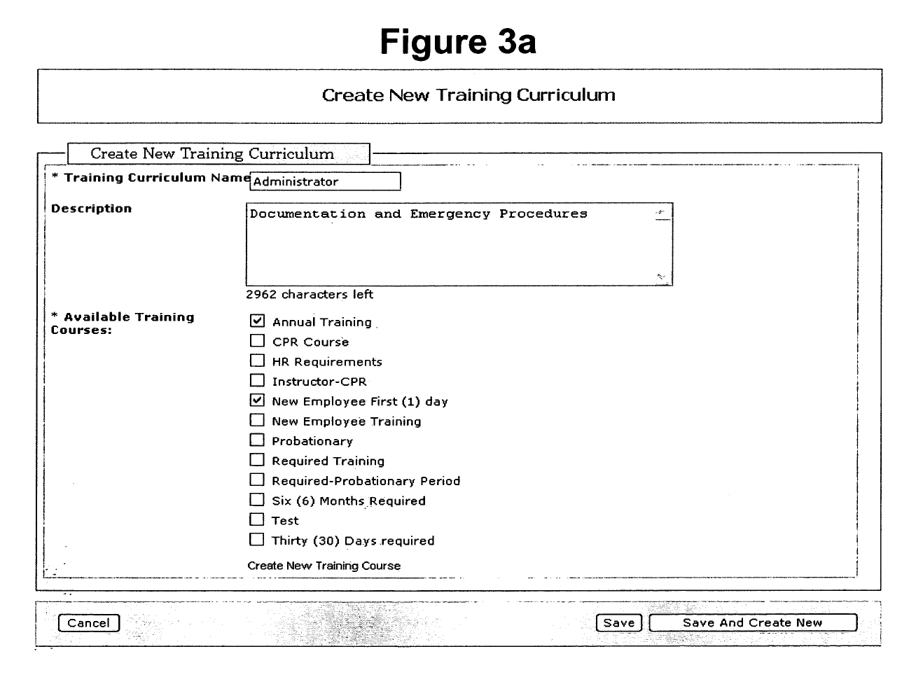

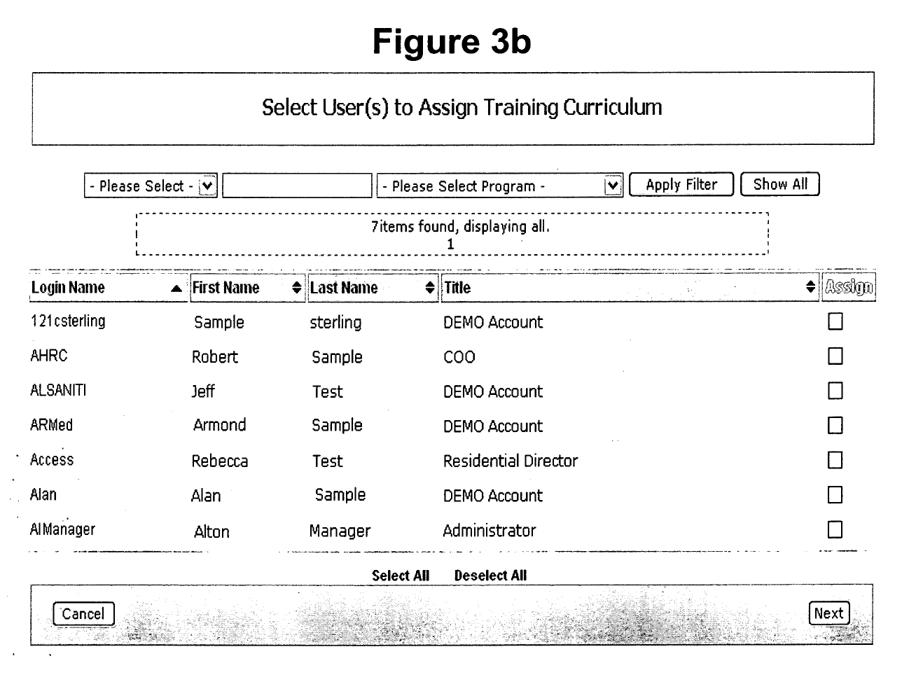

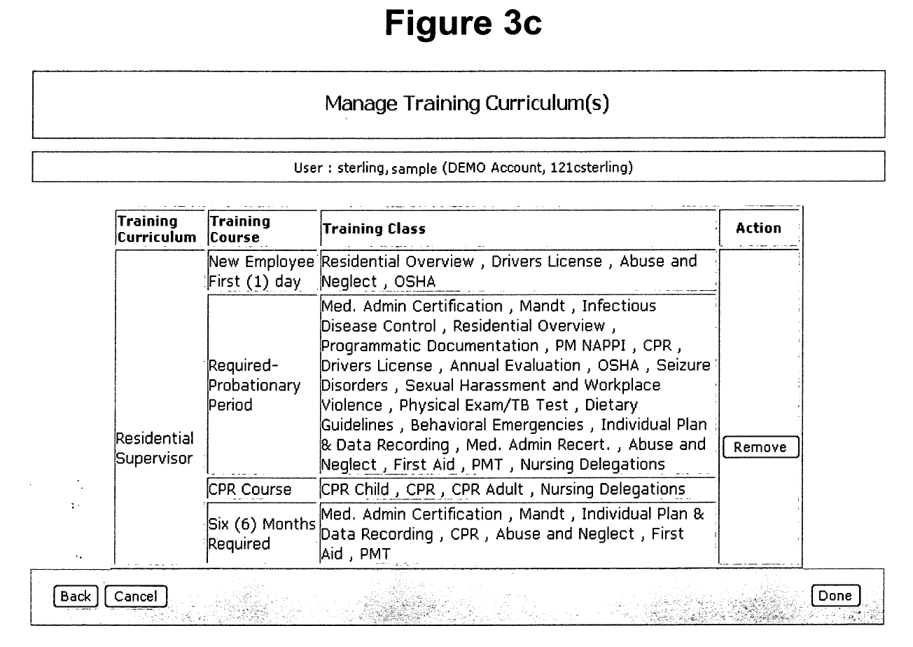

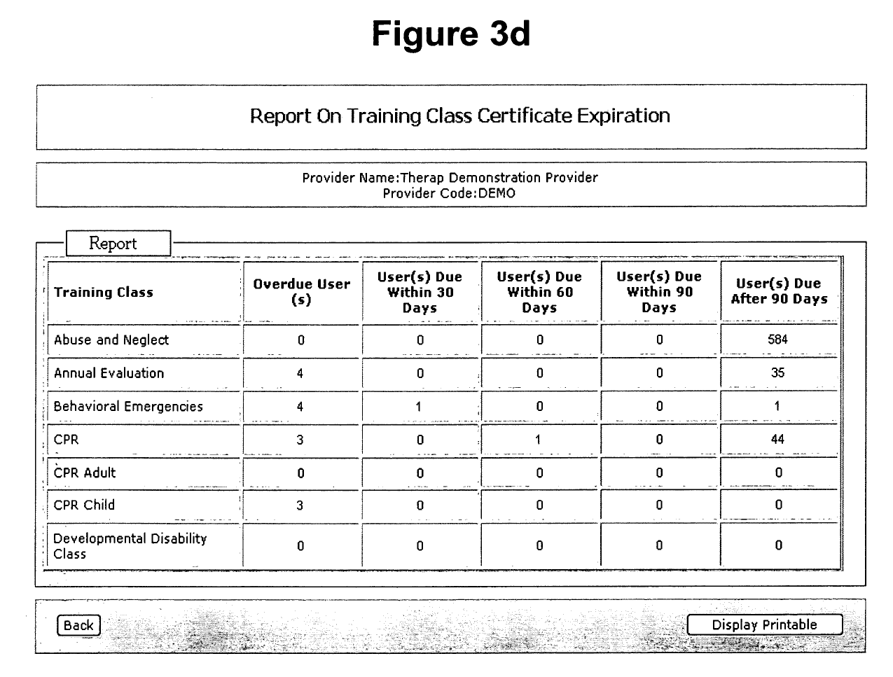

As shown in FIG. 3, M may represent a Learner working for Providers 1 and 2 and providing support to an Individual X. The example in FIG. 3 may illustrate a combination of Requirements from various sources for training Abuse and Neglect. FIG. 3 may also represent an example of relationships among Requirements and Goals from different sources. One Requirement for training may be related to other requirements, and representing this series of Requirements may be a preferred embodiment of the invention. For example, the State may have a set of requirements for Abuse and Neglect training for staff for individuals with Developmental Disabilities (DD). A Provider may expand on those requirements and the parent of a particular Individual may also expand on those requirements. The Learner may be requested to be aware of all of these relevant requirements and meet them all. The person managing Requirements for the Provider may be requested to be aware that the parent has established Requirements for dealing with a particular individual, and reflect that in the training requirements for staff members working with that individual.

As shown in FIG. 3, there may be a set of Federal Requirements for Abuse and Neglect 301. These Requirements may be a complex set of documents and not just a single document because of regulations and laws from a variety of different sources include court rulings.

The State may also have a set of requirements, State Requirements for Abuse and Neglect 302 training for staff providing support to Individuals with Developmental Disabilities (DD). The State Provider Association may provide the extract of relevant documents, as input to a Provider's requirements, in place of the details of the Federal and State versions.

Service providers, Provider 1 303 and Provider 2 304, may have their sets of Requirements for Abuse and Neglect training depending on the corresponding Federal and State Requirements. This may suggest that Providers 1 and 2 have authorized access to the State Requirements.

As shown in FIG. 3, plan for Individual X 305 may expand to include Requirements that may be set on the basis of the Individual's behavior and actions. This may be set by the Individual's parents or guardian, medical contacts, and other associates that may be related to Individual X.

Learner M 306 may have additional personal goals such as studying the legal aspects of Abuse and Neglect, which may be also essential and needs to be added in embodiments of the invention as requirements for the training.

Learner M may work for Provider 1 and Provider 2 as well as providing support for individual X so all of the Abuse and Neglect requirements may apply. The person managing requirements for the Provider may be requested to be aware that the parent or other authorized associates have established requirements for dealing with a particular Individual, and reflect that in the training requirements. Embodiments of the invention may provide mechanisms to manage and integrate the different Requirements through a common structure 307.

As shown in FIG. 3a, embodiments of the invention may allow the Provider to create Training Requirements based on State and Provider policies. These Requirements may be set by combining one or more resources available in embodiments of the invention. Embodiments of the invention may allow for Requirements to be set for each Learner based on past records and Individual, State and Provider needs.

The Training Requirements may be assigned to one or more Learners as shown in FIG. 3b. Once a Learner has been assigned a curriculum, the Learner may meet all Requirements set in curriculum to be eligible to carry out the job.

Embodiments of the invention may also have mechanisms for the person managing the requirements for the Provider to be aware of the established requirements, FIG. 3c. With proper authorization, the appropriate person may view the assignment of resources to different trainings and manage and update the resources used to create the trainings. Embodiments of the invention may comprise mechanisms that allow authorized people to track the certification expiration of the training requirements. Authorized users may view information such as the number of days within which certification may expire or the number of days that have exceeded the certification period, FIG. 3d. This may help to determine when the next training should be assigned to a Learner or if a Learner may be still eligible for a particular job.

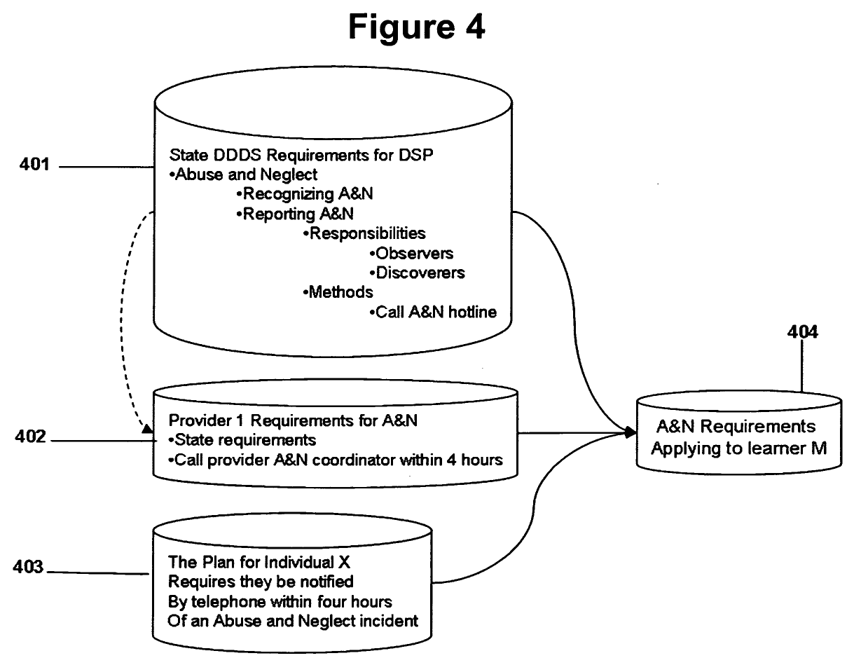

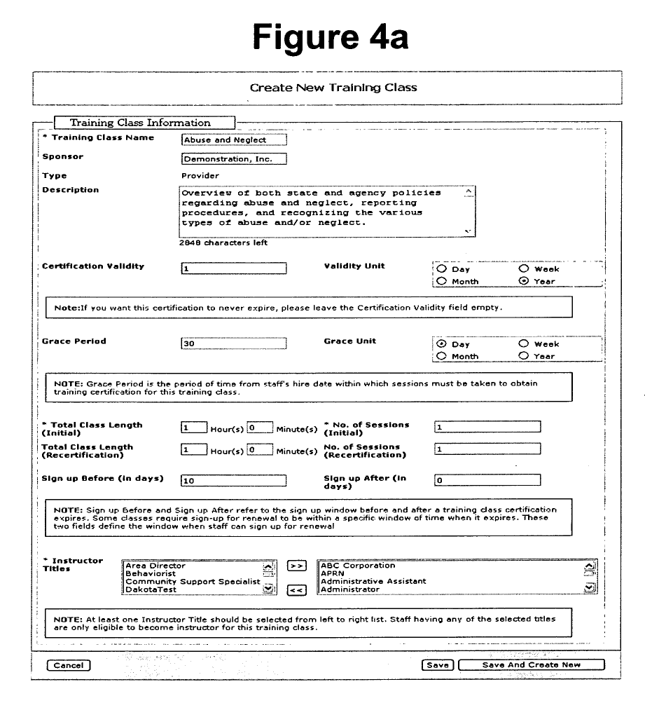

FIG. 4 may illustrate an Abuse and Neglect example of the State DDDS Requirements for a Direct Support Professional (DSP) supporting Individuals with Developmental Disabilities (DD), and how embodiments of the invention may combine the different requirements to determine the Requirements that may apply to Learner M.

The State DDDS Requirements for DSP 401 may request staff members to Recognize Abuse and Neglect and report Abuse and Neglect to different authorities. It may further define specific responsibilities of the observers and discoverers of an incident of Abuse and Neglect.

The State may also require specific methods of reporting such as calling the Abuse and Neglect Hotline and notifying the parent or guardian within 24 hours of observing or discovering the incident

There may also be a typical set of Requirements for a DSP set by Provider 1, supporting Individuals with Developmental Disabilities 402. The State Requirements may be included in the requirements for Provider 1. This may be linked to the corresponding State DDDS Requirements. There may be an additional requirement for notifying the Provider's Abuse & Neglect Coordinator, that may be to call the Provider Abuse and Neglect Coordinator within four hours of observing or discovering the incident.

Note: Provider 1 may wish to comply with the State Requirements for Abuse and Neglect.

The parents of Individual X require that they be notified by telephone within four hours of an incident of alleged Abuse and Neglect. This may be in addition to any other Requirements 403.

Learner M may work for Provider 1 and may provide support for Individual X and, therefore, a plurality of the Abuse and Neglect requirements mentioned in 1, 2, and 3 may need to be met in order for Learner M to be able to work with Individual X. Embodiments of the invention may provide mechanisms to determine a Learning Plan from all the applicable Requirements.

As shown in FIG. 4a, embodiments of the invention may have mechanisms to specify the overall requirements for Abuse and Neglect. The requirements may be a combination of State Requirements, Provider Requirements, and Individual and Learner Specific Requirements. Embodiments of the invention may also allow specification of certification validity, after which recertification may be requested for a particular job. It may further request different learning resources to be associated with a requirement and the specification of instructors who may carry out the training.

A preferred embodiment of the invention may be in its capacity in identifying the relevant Requirements and Goals, calculating and evaluating Learner characteristics and optimizing the Learning Process by comparing alternative plans. Embodiments of the invention may provide mechanisms for rendering the information anonymous, aggregating it, and extracting exactly what may be needed by a Learner or Learning Organization 307 to help them determine their Optimal Learning Plans.

Requirements and Goals may change with Learning Resources. For example, when a State DDDS Organization changes the regulations on Abuse and Neglect, they may also issue a summary of changes, and even slides to be used. These may constitute Learning Resources provided by the State DDDS, and, thus, an appropriate person in each Provider may be requested to learn the changes and receive a Learning Certificate. Then, they may create one or more Learning Resources for use by DSPs, Nurses, Administrators, and other members of the organization.

Each Learner or Learning Organization may request data about the benefits and costs of the alternative learning opportunities. A significant input to this may be the experiences of other Learners and organizations to help make decisions about how best to meet their own learning objectives. It may be inappropriate and would be a complete overload to share all the details of all users, so embodiments of the invention may provide algorithms to reduce the information to provide specific guidance to the Learner or Organization, and also manage the conditions of use of that information.

### Learning Resources

Learning Resources may be a primary mechanisms for learning. They may comprise the content and mechanisms used to help learn specific material. They may come from many different sources and in a wide variety of formats.

Learning Resources may have a wide variety of different characteristics. The different formats may be, for example, live or stored, a lecture or discussion, a document, multimedia presentation, or interactive game.

Formats for Learning Resources may comprise live forms such as classes, tutoring, discussions, and lectures plus stored forms such as books, audio, video, multi-media, interactive games, and a wide range of online experiences. Many of the resources may be outside embodiments of the invention, for example, people, physical objects, and online access systems, among others. However, some may be managed and delivered directly by or through embodiments of the invention, such as files or live chats and video conferences. The degree of interactivity of these Learning Resources may vary. For example, Learners may have the ability of watching a video, with only controls for play, stop, pause, and rewind among others. They may also be able to participate in an interactive program.

There may be various numbers of people involved. A Learner may interact with a stored resource or the Learner and another person may interact by means of talking or sharing information. Alternatively, a group of Learners may be involved, with our without an instructor, mentor or others, for example engaging in a multiplayer interactive program. Learning Resources may be created, used, and managed by a variety of different users, and embodiments of the invention may provide the mechanisms for these users to have accounts with defined roles and abilities, so they may interact with embodiments of the invention and the information in appropriate ways. Learning information may be provided to embodiments of the invention in a variety of forms that may be supported by embodiments of the invention: direct entry, loading of a variety of different file formats, direct collection by embodiments of the invention, and referencing resources outside embodiments of the invention which may comprise online access or real world experiences.

Learning Resources may be continuously accessed and updated in order to promote the process of learning. It may be essential to monitor the access of the resources to authenticate the user making changes to the resources. Tracking the access and management of resources also may play a role in detecting the source of the update. Embodiments of the invention may allow authorized input and access to sources of resources and record and notify of any update applied to such resources. The authorization, validation, and tracking of entry, use and management of this information may be provided by embodiments of the invention, applying appropriate levels of security depending on the information, the identity of the Learner or user, and the actions to be taken.

The information stored in embodiments of the invention may be available for use as requested, so embodiments of the invention may provide highly reliable storage, access, processing, and backup for all aspects of operations.

Embodiments of the invention may contain the ability to comprise materials associated with Learning Resources which may be not explicitly included in embodiments of the invention.

For example, the Learning Resource in question may be an online learning experience, or a live lecture attended by the Learner. Neither of these may be stored or available to embodiments of the invention directly; however, embodiments of the invention may allow for the inclusion of descriptive material, screenshots, Learner notes, slides used by the lecturer, and other supporting materials, possibly even comprising an audio or video recording of the lecture as taken by one of Learners, with the instructor's permission. Notes may be employed to record other Learners as well as instructors and others involved in this particular session in case there may be some sort of investigation of what occurred during a session.

In particular, tracking the versions at a particular time, so they may be related to changes in Requirements, Learning Resources, Testing Resources, and the validity of Learning Certificates, may be present in other embodiments of the invention. There may be different levels of integration of Learning Resources with a system embodying the invention. The Learning Resources may be stored within such a system and, therefore, completely controlled through this system. The resources may also be stored externally to such a system, but which may be accessed through such a system and, thus, such a system may monitor the detailed use of these Learning Resources. They may exist completely outside such a system but which provide results of the use of those Learning Resources through mutually agreed interfaces. There may also be Learning Resources which may be completely outside such a system and may not provide any information to such a system relating to monitoring and use.

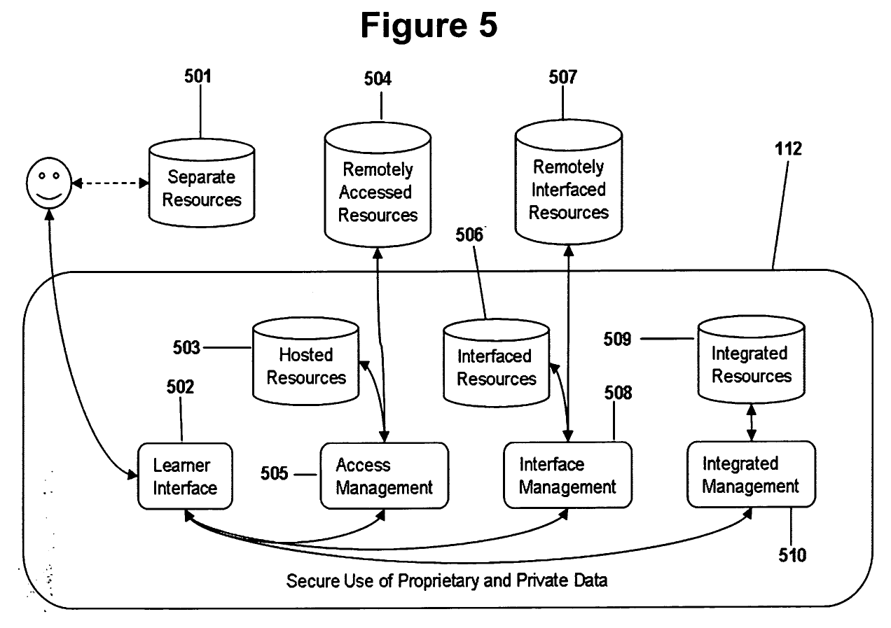

FIG. 5 may illustrate examples of relationships between resources and embodiments of the invention. Embodiments of the invention may prompt Learners to provide information. There may be some Separate Resources 501 that may have no direct link to a system embodying the invention. Separate Resources may exist completely outside such a system, for example, reading a book, or attending a lecture or discussion may be different forms of separate resources. Information entered by a Learner about these Resources may be available to such a system.

Resources may also be Remotely Accessed 504. These resources may be accessed through a computer, but may exist outside a system embodying the invention. Such a system may allow for the system browser or other access mechanism to be used to access Remote Resources. Such a system may not know the exact content of the Resource but may be able to give an idea of user activity on that Resource. For example, it may tell us how much time a Learner has spent on that Resource. Accessing a web based resource through the browser that may be implemented in embodiments of the invention, may give some information on number of clicks, for example. Embodiments of the invention may “estimate” what may be happening beyond this data.

There may also be Hosted Resources 503 that run on a computer that may be integrated into a system embodying the invention. These resources may comprise documents, recorded lectures, and web-based resources. They may be stored in such a system and accessed through embodiments of the invention, which may comprise browser or other access mechanism, but they may not provide direct information about the resource or its use. Remotely Interfaced Resources 507 may exist outside embodiments of the invention. Embodiments of the invention may have mechanisms that allow Remotely Interfaced Resources 507 to share information about the resource and Learner activity through the interface.

Integrated Resources 509 may exist within embodiments of the invention. For example, training materials about an embodiment of the invention may be fully integrated resources where the system knows everything that goes on and may give us more detailed information about the Learner and the resources. This may be enabled by the Integrated Management 510 Process that may give detailed information about the content that may be accessed and also Learner Activities on the resource.

Each Learner and learning organization may have many characteristics of their learning abilities, limitations, and preferences, which may affect how they learn best. Some of these characteristics may be entered explicitly to a system embodying the invention, for example, the Learner may have a physical disability, such as deafness or visual limitations. Other characteristics may be entered implicitly, for example, the user selects among choices in the course of using such a system which may be recorded. Other characteristics may be derived by embodiments of the invention in the course of use, for example, the amount of time and other resources used by a Learner for a particular learning experience and its effectiveness.

Embodiments of the invention may also provide data and algorithms to help in determining how efficient different Learning Resources may be for each Learner or learning organization. These may be based on several different methods. It compares the costs and resources requested for each of the alternative set of Learning Resources to meet the objectives. It may take into account how enjoyable a Learning Resource may be for the Learner or the Learning Organization. This may comprise, preferences expressed explicitly by the Learner or Learning Organization for Learning Resource types such as live classes, self-study, online interaction, books, audio material, video material and practical instruction. Resource types may also comprise schedules such as session duration or time of day and other resource types for example particular instructors or resource providers.

Embodiments of the invention may also allow for different mechanisms for using and monitoring the Learning Resources. The Learning Resources stored within a system embodying the invention may be therefore completely controlled through this system. Embodiments of the invention may monitor the learning resources that may be stored externally to such a system but which may be accessed through such a system. Such a system may also allow for tracking learning resources which may be completely outside such a system but which provide results of the use of those learning resources through mutually agreed interfaces.

Embodiments of the invention may also provide alternative mechanisms for using Learning and Testing Resources and passing appropriate information to the Optimal Learning System by means of separate, remotely accessed, interfaced and integrated resources.

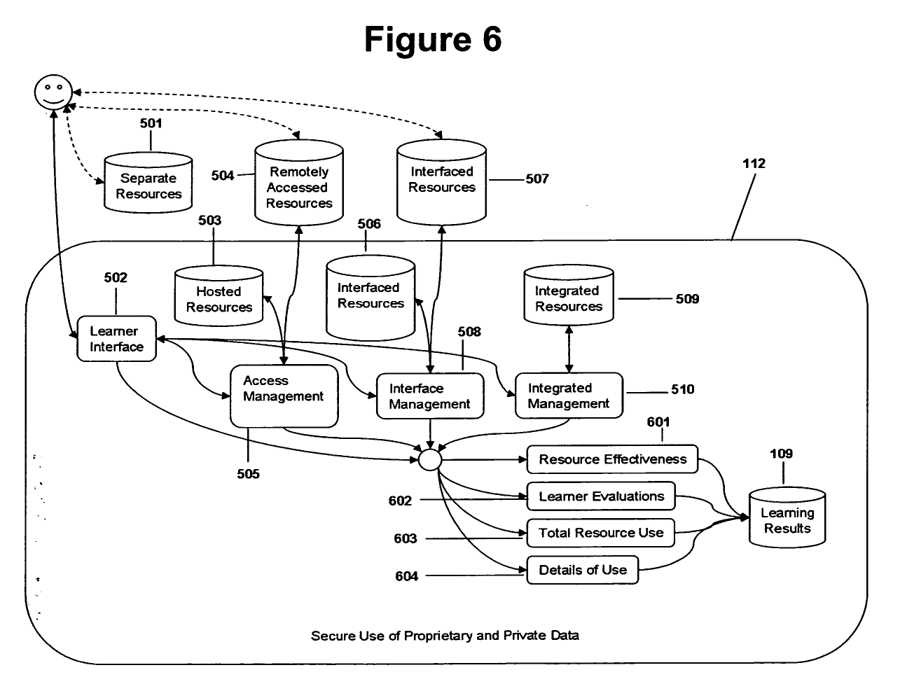

FIG. 6 illustrates how embodiments of the invention may have mechanisms that help a system embodying the invention to monitor the use of resources by the Learners.

The Access Management 505 mechanism may give such a system information about what resources outside such a system are being accessed by the Learner. The Interface Management 508 process may give such a system some information on the characteristics of the content that may be being accessed by a Learner. The Integrated Management 510 process may give such a system detailed information about the content that may be being accessed and also Learner activities on the resource.

Embodiments of the invention may have algorithms that take input from these processes to determine the Resource Effectiveness 601, collect Learner evaluations 602, measure total resource use 603, and record the details of use 604. These parameters may be evaluated in calculating the Learning Results 109.

### Non-Content Specific Activities to Assist the Learner

There may be learning resources which may significantly assist the learning process but may be not specific to a particular content area or may cover a broad range of content. Examples may include a dictionary, web searching, exercises to sharpen mental acuity, and games or other fun resources the Learner uses to reward themselves for achieving a goal. These resources may be not associated with specific requirements or goals, but may be associated with a broad area of content, or with the Learner or independent of their current focus. Making these resources available and even suggesting them to the Learner at appropriate times may significantly improve the Learner's performance. Thus, if a Learner may be suddenly becoming slow in processing a resource, or may be uncharacteristically poor at mastering a resource, it may be appropriate to recommend one or more alternatives. Appropriate presentation of these resources may be an important part of the learning process. For example, making a dictionary or glossary available at a single click or command and even putting the dictionary icon “forward”, may substantially improve the Learner's performance.

Allowing the Learner to set a goal, such as completing a given section with a minimum performance on a test, and then being rewarded with an appropriate fun resource may be helpful for some Learners. Another type of resource, which may be quite useful, may be the clock and schedule, reminding a Learner of a coming appointment, or a schedule if set, to achieve a certain milestone.

Providing these resources, which may include measuring their effectiveness in assisting the Learner, may be another aspect of monitoring and predicting the role and success of resources, largely separate from the details of Requirements and specific goals.

### Testing Resources

Testing Resources may be similar to Learning Resources in that they may take a variety of different forms and may be controlled by various embodiments of the invention. Embodiments of the invention may have mechanisms to enable each Testing Resource to interact with the user to determine whether they have learned what may be needed to meet certain Requirements or goals. Embodiments of the invention may also allow for mechanisms to compare with a Learning Resource to assure that it may be appropriate for the Learner to continue.

A system embodying the invention may enable users to specify criteria for successful completion of a Testing Resource. Successful completion of one or more Testing Resources may result in one or more Learning certifications for the Learner.

A Testing Resource may be an internal check within a Learning Resource to assure that may be appropriate for the Learner to continue, or as part of the pedagogical approach to teaching material, for example, the Socratic Method.

Testing Resources may be certified by some organization as meeting specified Requirements and goals. Successful completion of one or more Testing Resources may result in one or more Learning Certificates for the Learner. Criteria may be also specified for successful completion of the Testing Resource.

Testing Resources may comprise the following different components: a traditional test with “correct” answers to questions, essay questions which may request evaluation by a certified instructor, interaction with a computer program, which may be scored automatically or require intervention by a certified instructor, demonstration of practical experience in a realistic setting, which may be certified by a certified instructor.

Moreover, a Testing Resource may be linked into a specific set of Requirements and constraints; plus the related Learning Resources may be used for different purposes. For example, the same Learning Resource may be used for a direct support professional or for a nurse, but the questions may be more difficult for the nursing Requirements than for the direct support professional Requirements.

The Testing Resources may also depend on different Provider needs. For example, a Provider may establish a practical exam with guidance to certified Instructors for Abuse and Neglect. A Learning Resource may be established by this Provider to train the Instructors and how to certify staff for Abuse and Neglect training. Organization may also establish a Learning Resource for Instructors, so that they may be certified as Instructors.

A preferred embodiment of the invention includes the ability to relate the Testing Results and Learning Resources used with more than one set Requirements, including portability from one organization to another. Thus, a Learner may not have to go through the same training more than once if the existing Certificates, Testing Results, and Learning Resources qualify them to meet the several different Requirements. This may apply where a staff member works for more than one provider at the same time and one set of training may meet both sets of Requirements. If Requirements may be different then additional testing and certification may be required, but the Learning Resources may only need to be taken once, or one or more additional Learning Resources may be needed to meet the additional Requirements of one of the providers.

The following may be an example of Abuse and Neglect, in which examples of a number of different Learning Resources and ways they may be used may be shown. An example may be a multimedia training course from an Online Training organization which covers the Federal mandates for Abuse and Neglect and may be applied to Direct Support Professionals in the Developmental Disability (DD) industry as well as being linked to the Federal Requirements on Abuse and Neglect. The Learning Resource may be divided into sections in corresponding to specific topics in the Requirements and may comprise testing tools as part of the interactive package. It may provide a Certificate of Learning but also requires that a qualified person certifying the Learner has passed certain practical aspects and may provide detailed information to embodiments of the invention to track summaries of Requirements covered, and test results.

Another Learning Resource may be a lecture class developed by a Provider for new employees, and taught by an instructor from the same Provider. The outline of the class and selected slides may be entered by the Provider into an embodiment of the invention and asserts that these meet the Requirements of the State for Abuse and Neglect training as well. A separate test may be administered by the Provider and a Learning Certificate may be issued for complying with both State Requirements and Requirements from the Provider. The Learning Resource may be divided into sections corresponding to specific topics in the Requirements.

Another Learning Resource may be a lecture class developed by a Provider for annual recertification of employees, and taught by an instructor from the same Provider. The characteristics may be similar to the above course, but meeting the Requirements for recertification.

Another Learning Resource may be a brief presentation developed by a Provider to supplement the multimedia training course from the Online Training organization to cover specific State and Provider policies and procedures. The Learning Resource may comprise slides and text, and instructions for testing.

Another Learning Resource may be a self-study guide developed by the State to explain changes in the State Requirements and may be linked to specific changes made in the State Requirements, which may include instructions on who needs to take the Learning Resource and by what time, and may include instructions for testing and certification.

Another Learning Resource may be a video recorded lecture by an outstanding instructor covering all aspects of Abuse and Neglect in the State. The State has certified that this meets their Requirements for Abuse and Neglect training for both new and recertified Learners, and copies of slides may be provided.

Another Learning Resource may be a set of slides may be developed by a Provider to explain the additional provider specific policies beyond the video recorded lecture.

### Further Embodiments of Inventions on all Types of Resources

The boundaries among Resources may depend on the specific topic, and on the level of specification of Requirements. If a Requirement may be very specific, for example, any suspected Abuse and Neglect must be reported to the State Abuse and Neglect Hotline within 4 hours, then the corresponding Learning Resources may say exactly that, probably with some additional explanation and exhortation. Similarly, the Testing Resources may ask some form of the specific facts. If the topic may be very broad, and may depend substantially on the specific situation, then the Requirements may probably be correspondingly broad. For example, Abuse may take many different forms, so the Requirements may list some categories, but cannot go into detail, other than perhaps a few specific cases. The appropriate Learning Resource depends on the type of situations a DSP may be involved with, and the corresponding types of Abuse to be recognized, and they may go into more detail than the Requirements. For example, a DSP working with sedentary Individuals would be looking for suspicious bruising, and signs of verbal abuse. A DSP working rambunctious Individuals may expect to see a lot of bruising, and signs of verbal abuse would be quite different. The corresponding Testing Resources may also differ, and may be even more tailored to the specific situation. When the changes in a Requirement may be very specific, the organization setting the Requirements may provide a document describing the changes and giving examples. This document may be an appropriate Learning Resource for Learners already trained in the previous Requirements. An appropriate Testing Resource may just be questions on the list of changes.

### Learning Certificates

Learning Certificates may certify that a Learner or Learning organization has met specific Requirements, goals and constraints. A Learning Certificate may be an electronic document which contains the identity of the Learner being certified and the identity(s) of the user(s) authorizing the Learning Certificate. This may have links to their corresponding Learning Certificates showing they may be authorized to issue this Learning Certificate as well as comments about the certificate. The date and time a certificate may be issued. It also has links to the Requirements, goals and constraints, Learning Resources, and Testing Resources covered by the certificate, which may comprise identification of the versions. These versions may be implicit in the effective dates of the various resources. It may also comprise a link to specific results of Testing Resources. The title of the Learning Certificate may be used to identify the type of Learning Certificate the Learner may be required to gain in relation to a specific set of Requirements and Goals. The following may be examples of when a Learning Certificate may be required, used or obtained.

An embodiment of the invention, which may be termed as the Training Management System, may provide the ability for a Learner or Learning Instructor to track and manage all the Certifications requested by a particular Learner as well as informing the Learner of updates that may have been made to the Learning or Testing Resources. Embodiments of the invention may manage Learner training and communicates information about classes, certification, and expiration to all people involved. Training Coordinators, Supervisors, and Direct Support Professionals may all have access to the training information about themselves and the people they support each time they log into a system embodying the invention. Users may be granted access to TMS depending on their roles as Training Administrator, Training Supervisor, Training Instructor or other users of such a system. FIG. 2a, FIGS. 3a, 3b, 3c, 3d, FIG. 4a, FIG. 7a, FIG. 8a, FIGS. 9a, 9b, 9c may be all samples of a typical Training Management System.

Medicine Administration: the Learning Certificate may be requested to check whether a particular person may be allowed to administer medication to a patient or Individual and allowing this same person, for example, a resident nurse to delegate authorization to someone else to administer medication to a particular Individual or patient. For example, a registered nurse may be authorized to administer medication in the State of Connecticut as well as delegate this authorization to DSPs. Before delegating these duties however, the registered nurse may have to check whether the DSP that may be being delegated the duties has the proper Learning Certificate as well or whether it has expired. For a DSP to administer medications, they may need to have a Learning Certificate to pass medications which may be dependent upon the Nursing Certificate of the Registered Nurse who may be authorized to delegate duties. In order to be able to pass medications, the Learner Certificate may have to be valid as well as the Nursing Certificate. If either of them may be invalid or have expired, it may break the chain of certifications that has been established.

Expiration of certificates: Learning Certificates may have limited validity, for example, one year, after which the Learner may need to retake a certain course once the Learning Certificate has expired. If a certain set of Requirement and goals, set for the Learner has been updated, the previous Learning Certificate that the Learner has, may become void and, once again, he/she would have to update his Learning Certificate. A system embodying the invention may provide mechanisms to flag expirations and give warnings to all parties involved with the particular.

A preferred embodiment of the Optimal Learning Process may be tracking the expiration of Learning Certificates, for example, the interactive Testing Resource associated with the multimedia Abuse and Neglect Learning Resource, issues a certificate stating that the user has satisfactorily completed the lesson or course. The certificate may request that a corresponding practical examination certificate be obtained for this to be valid. The certificate may provide some level information about the level of achievement of Learner. This may be at the level of a transcript rather than a detailed summary.

Another example would be that of a certified instructor in Abuse and Neglect from a particular Provider may issue a certificate of completion of the various Abuse and Neglect Training Resources in that same Provider. The Instructor must currently be certified to issue a Learning Certificate in that particular Training Resource.

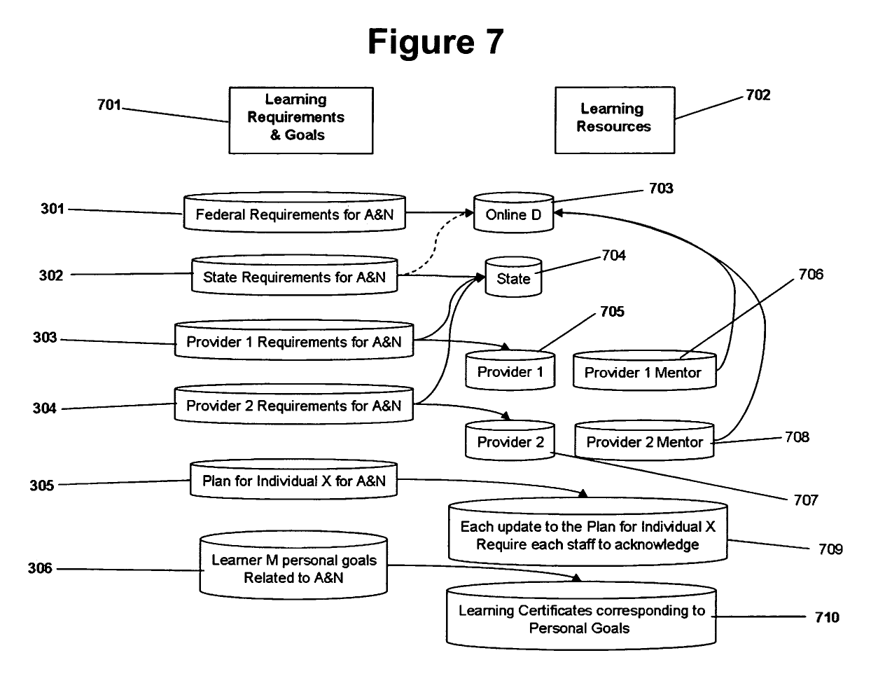

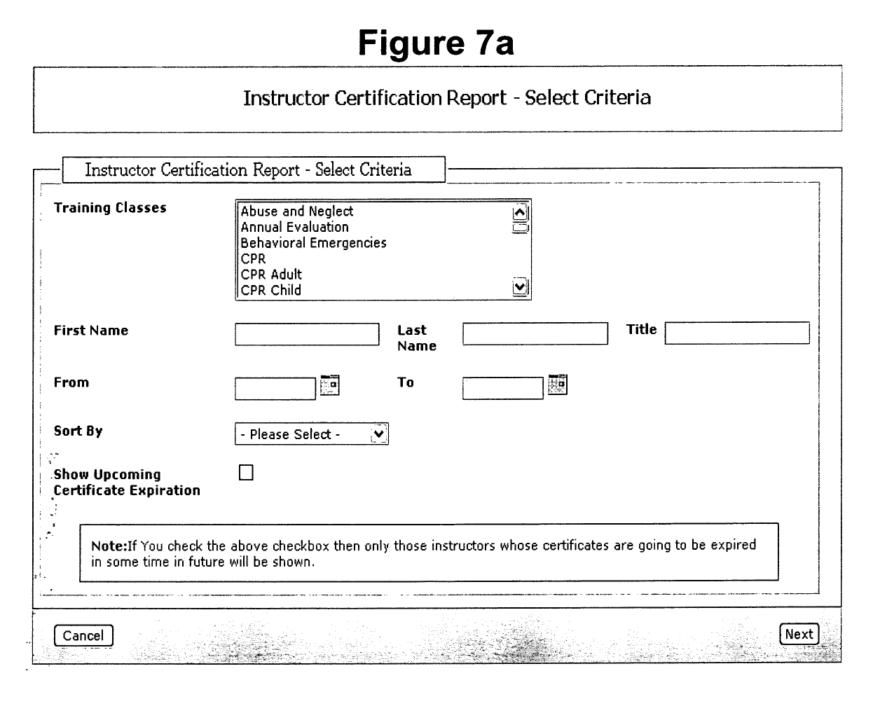

FIG. 7 may refer to examples of certificates that correspond to a certain set of Requirements and Goals for the case of Abuse and Neglect. The Learning Requirements and Goals 701 may comprise various Requirements that may apply to a Learner who may be interested in taking a course on Abuse and Neglect (see also FIG. 3). On the right hand side of FIG. 7, may be the corresponding Learning Resources 702 that may be obtained for each set of Requirements and goals. Online D 703 may be the online testing or Learning Resource that the Learner may have to go through in order for him to obtain a Learning Certificate. It may be possible that Online D 703 may not cover the State specific Requirements. Online D Learning Resource may also request that provider mentoring may be obtained 706 and 708 respectively in order to be awarded a Learning Certificate. In order for a Learner to be awarded a Certificate from Provider 1 705, the Learner may need to have the Provider 1 Requirements for A&N 303 as well as a Provider 1 Mentor 706 in order to be able to go through the Learning Resource and obtain the Learning Certificate.

The Learning Certificates that may be awarded by the State 704 may comprise State Requirements for A&N 302, Provider 1 Requirements for A&N 303, and Provider 2 Requirements for A&N 304.

The Plan for an Individual X for A & N 305 may also be periodically updated as the Individual improves or may move on to a new Plan. Each update to the Plan requires each staff to acknowledge 709 the fact that they may be aware of the change to the Plan and so, verify if they have the updated Learning Certificate.

A particular Learner M may have personal goals related to A&N 306 and may require Learning Certificates corresponding to those personal goals 710.

FIG. 7a may be a sample of an Instructor Certification Report where embodiments of the invention may have mechanisms for authorized users to view certification reports of instructors on the different training Requirements. Authorized users may also view the certification expiration of the instructors. Once a certification expires, the instructor may not be able to conduct further trainings unless recertification has been obtained. This may ensure that all trainings may be up to date and meet the changes and updates in Requirements.

### Optimal Learning and Certification Process

Given an Optimal Learning Plan, embodiments of the invention may provide methods to implement the Learning Plan, provide certification that the Learning has been successfully completed, and gather the data generated by using the system to update the information used in evaluating and planning. Embodiments of the invention may also support monitoring and updating the Plans as changes occur in the information.

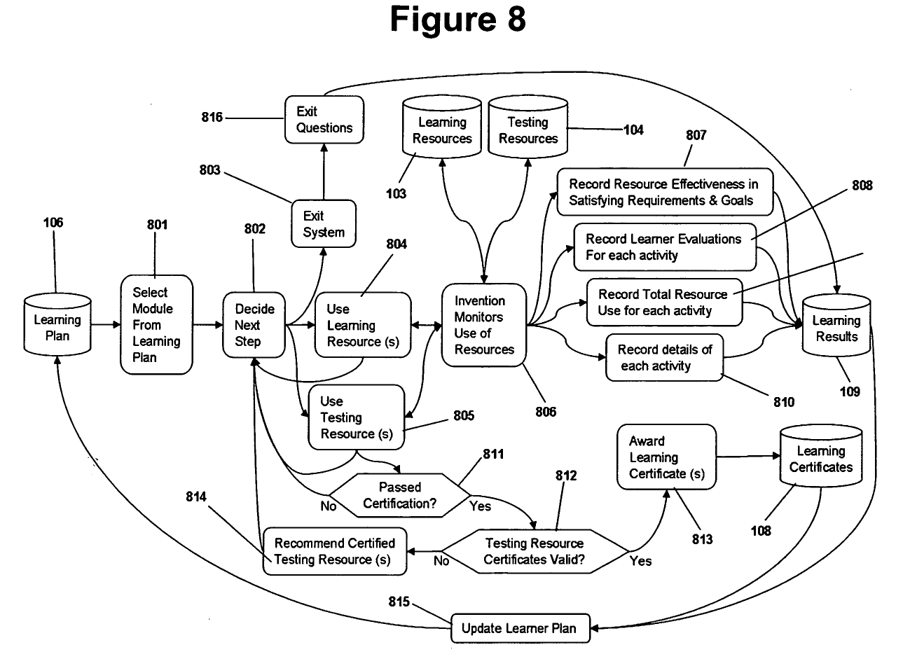

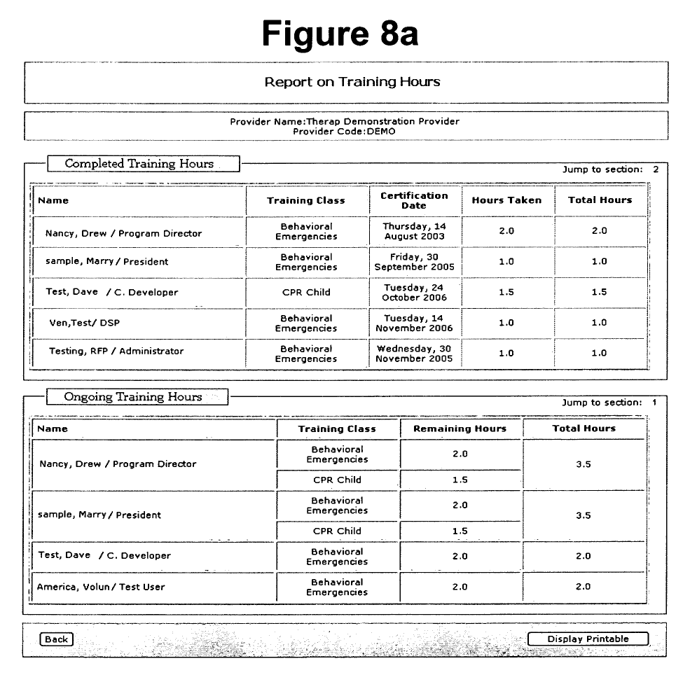

FIG. 8 may provide an example of storing the details of use of a resource by a Learner for subsequent analysis and evaluation. As shown in FIG. 8, embodiments of the invention may allow the system to store the basic Learning Plans 106 provided by the government, academic institutions, professional, technical, and other associations. The Learner then chooses the Module from the Learning Plan 801 that best suits their Requirements, defined by the organization. The Learner then may have the following options of steps to choose 802: Exit the system 803, Select a Learning Resource(s) to use 804 or use a Testing Resource 805.

If the Learner decides to use the Learning Resource 804, embodiments of the invention may monitor the use of resources 806. From there, a system embodying the invention may then record the resource effectiveness in satisfying Requirements and Goals 807, the Learner evaluations for each activity 808, the total resource used for each activity 809, and the details of each activity 810. These may be all then stored in Learning Results 109. After using the Learning Resource 804, the Learner may go back and decide what their next step would be 803.

Alternatively, the Learner may decide to use the Testing Resource 805 either before using the Learning Resource 804, or after. The system checks to see whether the Learner has passed the certification 811. If yes, then such a system checks whether the Testing Resource certificates of the Learner may be valid 812. If they may be, then the Learner may be awarded a Learning Certificate 813 and this may be stored in the database of the Learning Certificates 108 for that particular Learner.

However, if the Learner does not pass the certification 811 after using the Testing Resource 805 then such a system may go back to where the Learner may decide 802 whether to use further Learning Resources 804 or exit the system 803. If the Learner passes the certification 811 but has invalid Testing Resource certificates 812, then such a system may recommend the certified Testing Resources 814 that may be available to the Learner and allow the Learner to decide what their next step may be 802.

Learning Certificates 108 and Learning results 109 of a Learner may be continually being updated and, thus, embodiments of the invention may also have the mechanism to update the Learner Plan 815 and then store it In the Learning Plan 106 where the former Plan existed.

When the Learner decides to logout of the system 803, such a system may ask certain questions 816 for example, information pertaining to their overall enjoyment of the system, user friendliness or feedback, the replies to which may be then stored in the Learning Results 109.

FIG. 8a illustrates a sample of a Training Hour Report where a system embodying the invention may have mechanisms to store reports on the training hours of Learners. The system monitors the number of training hours taken by different Learners. This may enable authorized users to verify that trainings may be duly completed by Learners in the correct time. It also may check to see if a Learner has a valid certification or if the certification has expired and tracks the number of days within which it may expire. This ensures that when a certification expires, Learners may be re-assigned to different trainings to meet the Requirements.

Such a system may then provide the Learner with the information and algorithms to evaluate alternatives to select a Learner Plan based on complex situations involving Requirements, availability, costs, resources, schedules, and Learner choices.

Learner situations define which Requirements need to be met. One example may be job Requirements may be set by the organization that the Learner has been or may be working for. Here, such a system may allow matching the Learner's current capabilities to the specific Requirements; a Direct Support Professional, providing direct support to an Individual for Residential Services for Developmental Disabilities in a particular State.

Another example may be professional Requirements, such as a registered nurse in a State. Another example may be academic Requirements, such as BS in Nursing from a particular university.

Other examples may be based on situations as they arise, such as a course in Recognizing and Reporting Suspected Abuse and Neglect following a specific incident.

The Learner must balance the many complex inputs to establish their own Learner Plan. Such a system may provide the information and the algorithms to estimate the resources required by the Learner for different alternatives. Such a system may allow the user to evaluate multiple alternatives and even optimize selections based on weighting and criteria supplied by the user in an iterative process. As the Learner makes broad decisions, and those may be accepted, then successively more detailed decisions may be evaluated and selected. This may be iterative, for example, choosing a university and getting accepted, then choosing a major, and then choosing a set of courses for a semester.

### Selecting a Portion of a Learning Plan

The reason for selecting a portion of the Plan may be to focus the identification and prediction of ratings to a set of Learning and Testing Resources which meet the specific set of Requirements being addressed.

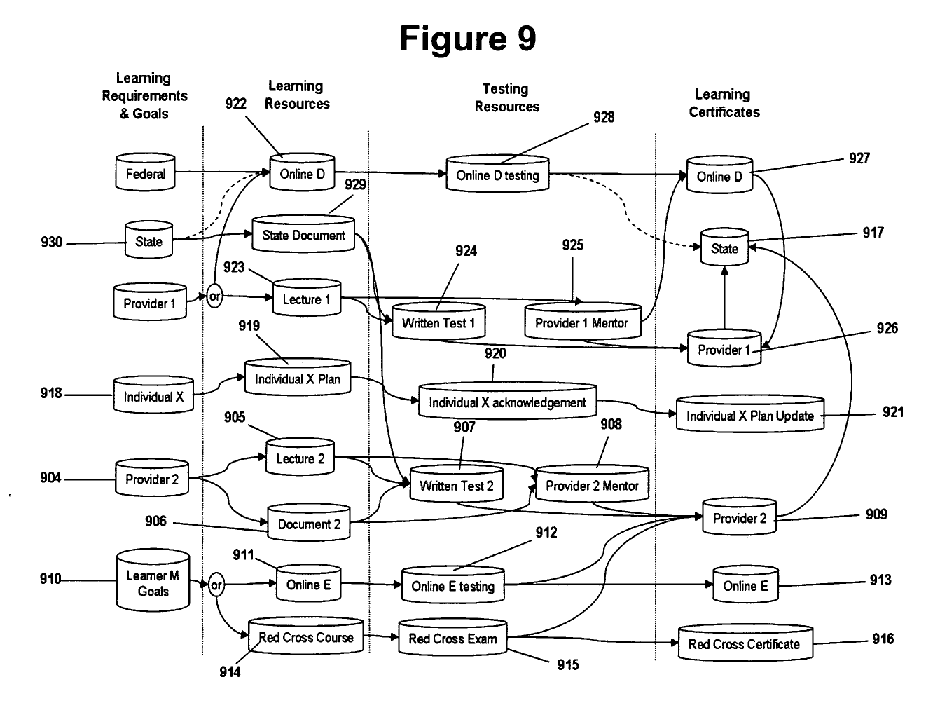

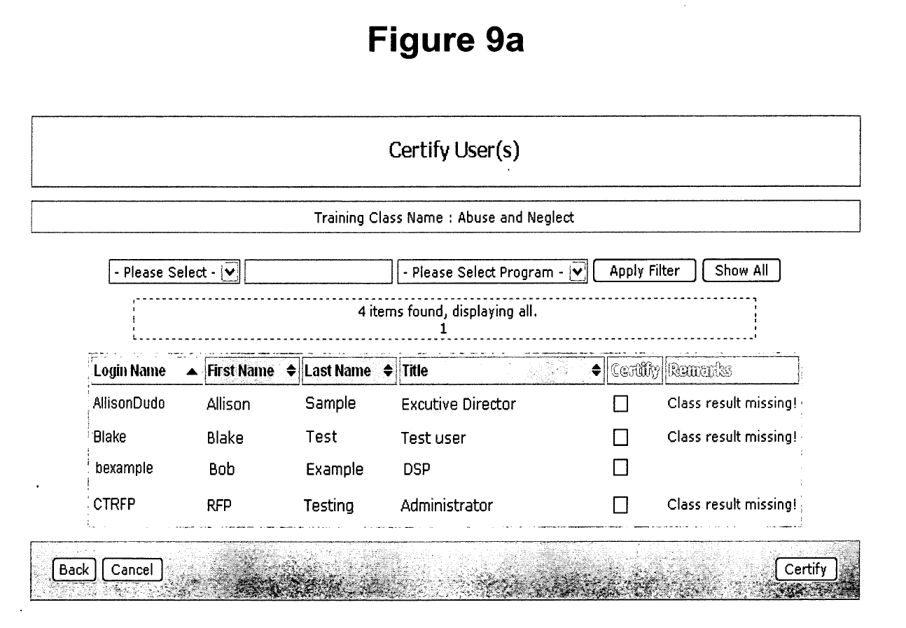

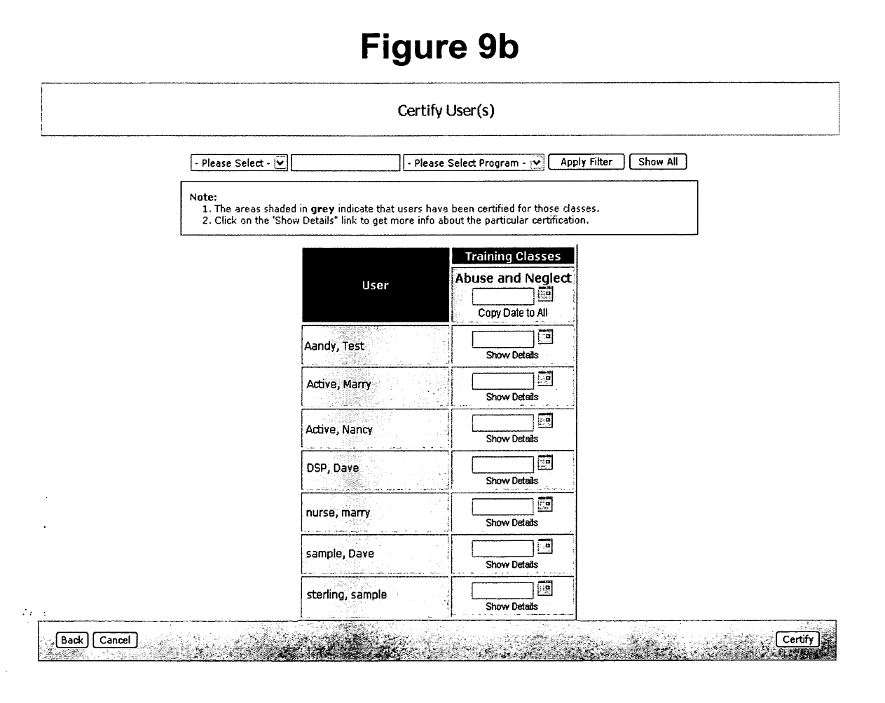

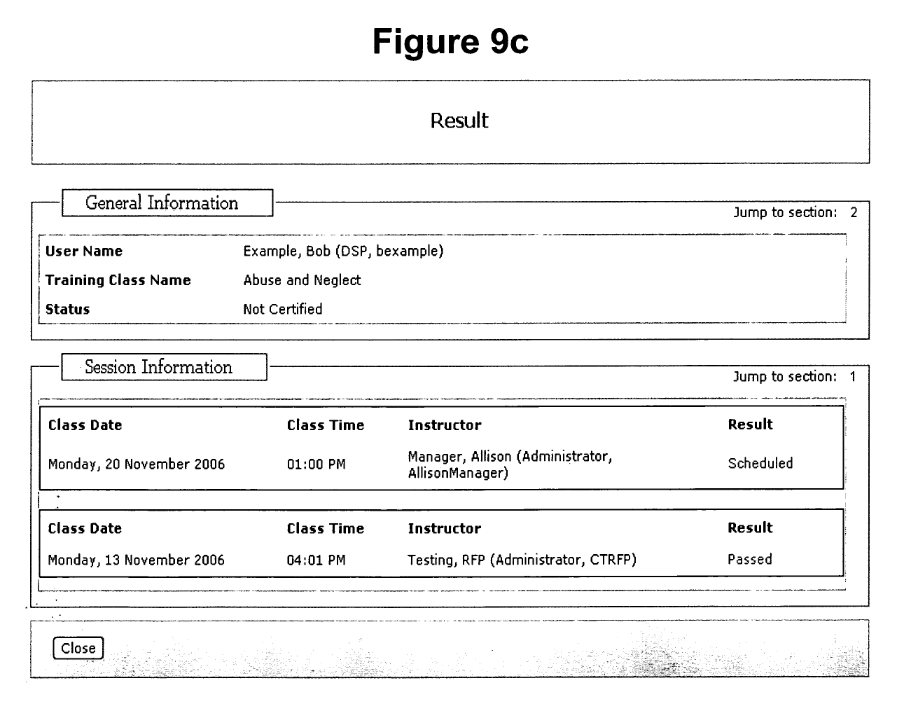

FIG. 9 may demonstrate an example of the resources and certificates that may be obtained from a Learner Plan.

Provider 2 Learning Requirements and Goals 904 may provide Learning Resources Lecture 2 905 and Document 2 906. The Written Test 2 Testing Resource 907 may be based on the materials covered by Lecture 2 905 and Document 2 906. Once the Learner has completed the respective Provider 2 Learning Resources 905 and 906, they may have to go for Mentoring 908 set by Provider 2 904 in order to get a Learning Certificate from Provider 2 909.

Learner M may have separate goals 910 due to their own interest and may go through the Online E Learning Resources 911 and Testing Resource Online E 912 and get a Learning Certificate for Online E 913. Learner M's Requirements and Goals 910 may also comprise an alternate Course Learning Resource from Red Cross 914. Learner M may then go through the Red Cross examination 915 and be awarded a Red Cross Learning Certificate 916. The Online E Test 912 as well as the Red Cross Exam 915 may also be the criteria in order to get a Learning Certificate from Provider 2 909. Thus Learner M may indirectly be awarded a State Learning Certificate 917 as well since Learner M has been awarded a Provider 2 Learning Certificate 909 which may be recognized by the State 917.

Individual X 918 has specific Learning Requirements and Goals that may be related to the individual and their Plan may be used as a Learning Resource 919. Whenever the Plan for Individual X may be changed, the Learner may be required to acknowledge 920 the changed Plan and update themselves according to Individual X's Plan update 921.

Provider 1 may specify Online D 922 as their Learning Resource as well as Lecture 1 923 which may be provider specific. Written test 1 924 and Mentoring from Provider 1 925 may be prerequisites to gaining a Learning Certificate from Provider 1 926. Thus, Provider 1 accepts the Online D Learning Certificate 927 as well.

In order to obtain an Online D Learning Certificate 927, a user may have to either go through the online D Learning Resources 922 and Online D Testing Resources 928 or Take the Written Test 1 924 and have Provider 1 Mentoring 925. Provider 1 may accept the Online D Learning Certificate 927, as it requires that Provider 1 Mentoring be obtained as part of its Learning Certificate Requirements.

The State 917 may also accept Provider 1 and Provider 2 Learning Certificates 926 and 909 respectively as the State Document Learning Resource 929 specifies that Written Test 1 924 and Written Test 2 907 as well as Mentoring from Provider 1 925 and 2 908 may be recognized as Testing Resources in order to obtain a Learning Certificate from the State 917.

Online D Learning Resources or Testing Resources may not necessarily cover State specific Requirements 930.

As shown in FIG. 9a, embodiments of the invention may have mechanisms for the provider to award certificates to users upon successful completion of a Plan and publish the result. It may enable current certifications to be entered into a system embodying the invention, so it may be tracked what each Learner has accomplished so far from the trainings. As shown in FIG. 9b, it also allows past certification of Learners to be entered into such a system that gives background information on what a Learner had achieved in the past. For each certification that may be recorded, authorized users may view and compare past records with current. Embodiments of the invention may comprise allowing users to view details of all past and present records in such a system.

FIG. 9c illustrates how embodiments of the invention may allow authorized users to publish results for training that has been taken by a Learner. Users may view the status of each Learner for a particular training.

### Algorithms and Tools for Monitoring Learning

Embodiments of the invention allow users to monitor the use of resources to assist in analysis and evaluation of the effectiveness, efficiency, and enjoyment of using particular resources to accomplish specific Requirements and Goals

A user's involvement and interaction with respect to a particular part of a system embodying the invention, for example, when a user accesses a particular Learning Resource, may be monitored by means of a specially “instrumented” browser i.e., an ‘add on’ to the user's browser. Actions such as the number of clicks on a particular button, or which page in particular has been viewed, as well as preferences may be monitored using JavaScript tools for instance, to track what users may be doing. The level of interaction, learning material the user prefers to use, the Learning material they may find strenuous or tedious; tracking all these may help determine and shape the type of Learning Resources which may be preferable and beneficial to the user.

### Learning Certification and Certificates

The key aspect of most Learning applications may be the need for formal certification that a Learner has achieved specific objectives, and embodiments of this invention may comprise methods for entering, using, and establishing the authenticity of Learning Certificates. Embodiments of the invention may provide a mechanism for recording and verifying Learning Certificates, which certify that a Learner or Learning organization has met specific Requirements and constraints such as the following:

A “chain of Learning Certificates” which may verify that the whole set of dependent Learning Certificates were valid when a particular Learning Certificate was issued. For example, if a Learner must be tested by a certified registered nurse, then the certification of the Learner may be dependent upon the certification for the registered nurse being valid and the person who enters the certification for the nurse needs to certify that it may be valid. This succession of responsibility shows that organizations may be displaying appropriate diligence in managing their operations, as required by their license and applicable regulations and laws—as shown, at least partially, in the Requirements. The Optimal Learning Process may match the Testing Resources with the corresponding Requirements and constraints for which they may be authorized to certify completion or partial completion.

### Evaluating Learner Experience

Embodiments of the invention may provide mechanisms, for example, tools for evaluation, for using the variety of information available to evaluate the cost, benefits, and other resources required for various learning methods, while meeting the many constraints. Additional methods use this information to determine the Optimal Learning method based on the values assigned by the person looking for the Optimal Learning Plan.

It may be requested to choose a subset of a Learner Plan for evaluation since the user may be using a number of Learning Resources. Separating it into a portion of a Learning Plan may allow a system embodying the invention to localize the specific Learning Resources that the Learner may be using to focus on a particular Learning Certificate.

A part of optimization may be measures of the desirability of a particular alternative and embodiments of the invention may provide a combination of measures to balance the different aspects of measures for evaluation.

Embodiments of the invention may provide data and algorithms to help in determining the effectiveness of different Learning Resources for each Learner or Learning organization. These may be termed as E-Cubed ratings and may be based on several different methods:

Effectiveness: this may be based on how effective a particular Plan may be in accomplishing the specific Learning objectives, typically achieving one or more Learning certifications. It may be also the fraction of Learners that passed the certificate that this Learning Resource may be being used for. This may be expanded when multiple Learning Resources may be used to pass the same Learning Certificate, so that the set of Learning Resources used by the Learner may be tracked before they take the test. This may be an example of why it may be important to choose a subset of a Learner Plan for evaluation, because the Learner may be using dozens of Learning Resources, but separating it into a portion of a Learning Plan allows us to localize the specific Learning Resources that they may be using to focus on this particular Learning Certificate

Efficiency: this may measure of the amount of resources used to effectively use a given Learning Resource which may comprise having to go back and use the Learning Resource more than once to be able to pass the Learning Certificate; resources may comprise a Learner's time, the pro-rated amount of an instructor's time (for example if there may be five students in a class for an hour with one instructor, each student may be allocated 12 minutes of instructor time), the cost of the Learning Resources, and other significant resources, potentially comprising computer time, and other resources.

Enjoyment: this may measure how satisfied the Learner or Learning organization may be with that particular Plan, whether the Learning experience met their person objectives or was enjoyable. A variety of measures may be used to determine the Learners' overall enjoyment, for example, a survey at the end of the entire Learning experience to determine the Learners' satisfaction with the Learning Resource. Each Learning Resource may be more or less enjoyable for the Learner or the Learning organization. Preferences may be expressed explicitly by the Learner or Learning organization for Learning Resource types (example, live classes, self-study, online interaction, books, audio material, video material, and practical instruction), schedules (for example, session duration, time of day), and others (example, particular instructors or resource providers). Preferences may be expressed implicitly by the Learner using evaluation tools which may allow embodiments of the invention to determine the Learners' enjoyment of each Learning Resource they use.

Combined measures: while each of these measures may be useful in itself, it may be the combined effect which may be requested for selecting optimization, and embodiments of the invention may provide an algorithm for creating flexible optimality criteria. Final decision making by users may take into account the different measures in comparing alternatives.

### Predicting Learner and Resource Evaluations

There may be at least two types of E-Cubed ratings that may be obtained regarding a Learner. One may be the Predicted E-Cubed rating of a Learner where based on the Learners' choice of resources and Learning experience, a system embodying the invention may use algorithms to predict the overall E-Cubed rating of the user. The other type may be the Actual E-Cubed rating of the Learner which may be obtained once the Learner has actually gone through the entire Learning experience and may be awarded actual Learners' Certificates based on his performance, or given up.

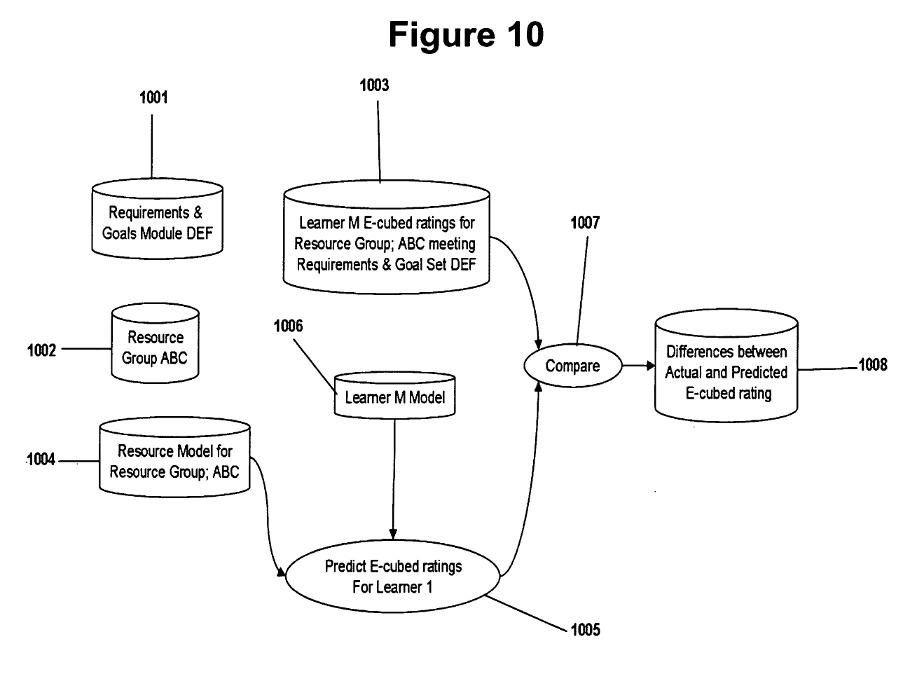

Referring to FIG. 10, a Learner M may have a particular set of Requirements and Goals set for him called Module DEF 1001 according to what the Learner needs to achieve. Resource Group ABC 1002 may be the set resources the Learner requires in order to meet the Requirements and Goals set for him in Module DEF 1001. Learner M then goes through the relevant resources and the E-Cubed ratings may be calculated for the Resource Group ABC meeting the Requirements and Goal Set DEF. These may be the actual ratings of Learner M 1003.

Resource Model for Resource Group ABC 1004 may represent a predictive model of a typical set of resources that Learner M may request. This may be complex since alternate Testing Resources may also be included as well as other Learning Resources besides the ones that the Learner may request to fulfill the Learner Requirements and goals. The Resource Model for Resource Group ABC 1004 may be then used to predict the E-Cubed ratings that may be provided by Learner M 1005. The predicted E-Cubed ratings for Learner M 1005 may be quite simple, for example, for text, a system embodying the invention may just rate the reading speed, or the level of difficulty, comprehension and retention and this may be used as simple parameters for prediction based on the Learner's characteristics in each of these parameters. This, however, may increase in complexity if the Learner already has some knowledge and skills in the area of DEF, i.e., the Learner may not be a novice. For example, such a system may check whether the Learner has taken all the prerequisites for the particular Resource Group ABC. Prerequisites may be important in deciding how useful resources may be.

Together with the predicted E-Cubed ratings for Learner M 1005 and the Learner M Model 1006 such a system may then compare 1007 the actual E-Cubed ratings for Resource Group ABC meeting Requirements & Goal set DEF 1003 and generate the differences between the Actual and Predicted E-Cubed rating 1008. The results that may be acquired may be quite varied as this may be a multiple parameter comparison. This may be the data that may be needed to improve the Learner and Resource models in general, the Learner Model for Learner M, the Resource Model for Resource Group ABC, and more efficient prediction algorithms which may be a continual process aimed at further improving the effectiveness of such algorithms.

Combining the Prior Experiences of Other Learners “Most Relevant to the Learner” with this Resource to Predict Resource Evaluation

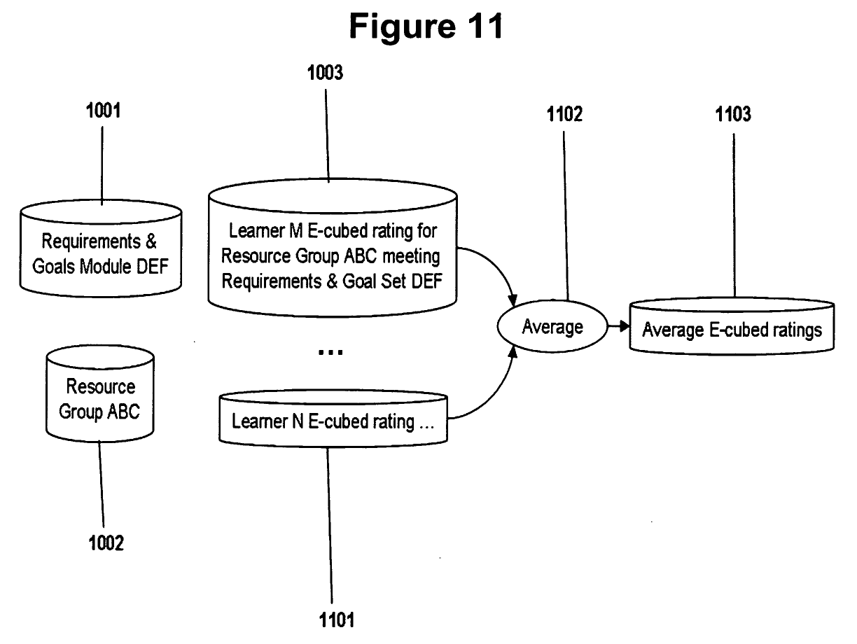

FIG. 11 may demonstrate the simplest case for predicting resource evaluation using E-Cubed Ratings from a set of Requirements & Goals Module DEF 1001 and Resource Group ABC 1002. Learner M may have E-Cubed ratings for Resource Group ABC that meet the Requirements & Goal Set DEF 1003. Learner N may have separate E-Cubed ratings based on the same Requirements & Goals Module and Resource Group 1101. These ratings may be then averaged 1102 to give overall average of all the E-Cubed ratings 1103.

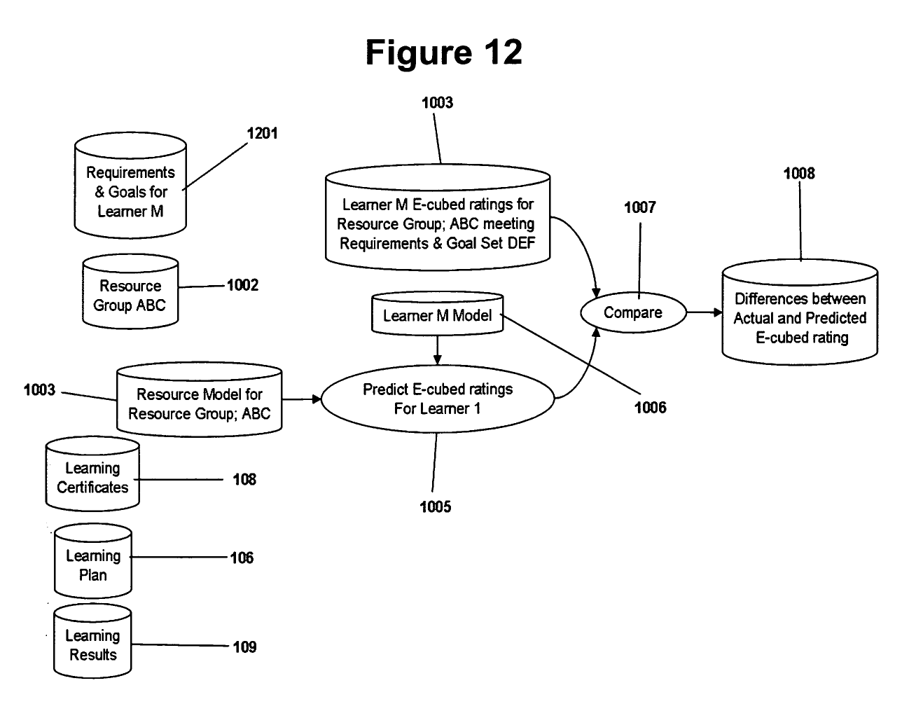

FIG. 12 may demonstrate a specific instance of finding Learners with “similar models” to Learner M. This case may be similar to FIG. 10, except for the fact that there may be Requirements and Goals specific to Learner M 1201. This helps determine what Learner M may be supposed to be covering, so that similar Learners may be found to match these.

In FIG. 8, Learning Certificates 108 for Learner M may be comprised to help determine if the prerequisites have been satisfied. Learning Plan 106 helps to determine what Learner M has planned so far, so that similar Learners may be found to match Learner M's criteria. Similarly, E-Cubed ratings on a plurality of resources used, old Learning Certificates of Learner M may be stored in Learning Results 109.

### Storing Learning Results & History

A preferred embodiment of the Optimal Learning Process may be having a flexible mechanism for recording Learning Results. This may depend on a use of detailed results of learning both by a Learner and other users of embodiments of the invention; thus, a preferred embodiment of the invention may comprise the ability to record the various Learning Results so that they may be used by other Learners in the process.

### Automatic Archiving Process and Archives

The actions and results of each Learner need to be archived so they may be retrieved when needed. It may be necessary to determine what some of the information was used by a particular Learner as part of an investigation of appropriate actions in response to an event. Archives may comprise the content of a Learning Resource, answers to test questions, and its correctness, other resources used, date, time and duration of sessions, the instructor or other staff involved or any certificates obtained.

Data archives may be provided by a system embodying the invention to track the version and the history of changes to information so that even though a Learning Resource may be changed by its owner, the version used by the Learner may be retained. Such a system may allow this to be done for unmanaged resources. Even if the full details of the externally managed Learning and Testing Resources may be not available, checking against the detailed Requirements and Goals may help in tracking changes throughout.

### Optimal Learning Planning Process

A system embodying the invention may provide mechanisms for using the variety of information available to evaluate the cost, benefits, and other resources required for various learning methods, while meeting the many constraints. Such a system may use this information to determine the optimal learning method based on the values calculated for the Learner looking for the Optimal Learning Plan.

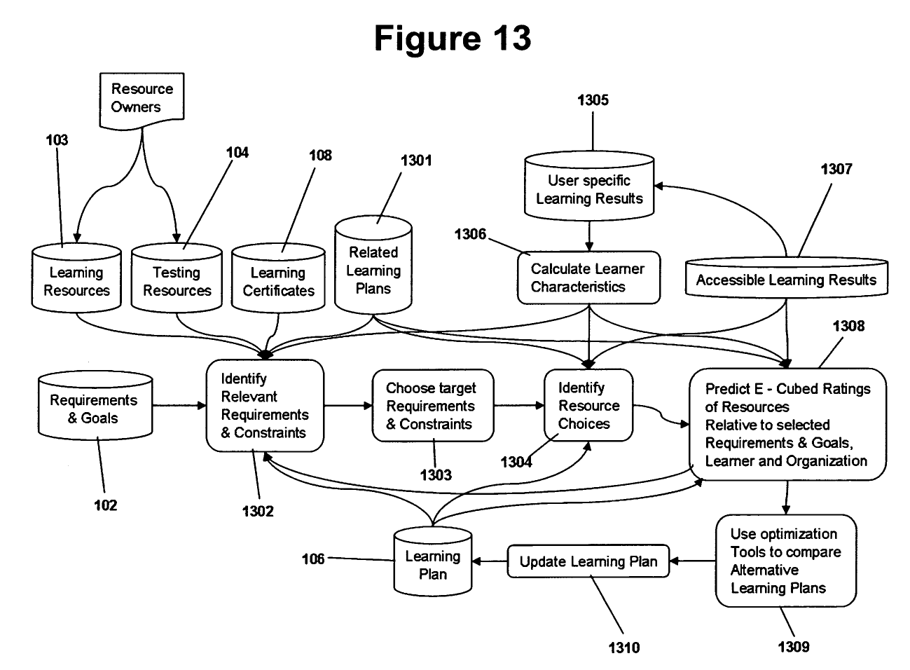

FIG. 13 illustrates a mechanism that embodiments of the invention may provide for Evaluation and Optimization for Learning Decision Making.

The Learning Decision Making Process may begin with determining what Requirements the Learning Plan needs to meet, for example, deciding which Requirements apply to a particular Learner or Learning Organization. The Requirements may be organized with links to particular jobs, and tasks among others. A Learning Organization may have staff who may be assigned to determine which Requirements apply to the Organization, and then to specify those that apply to different Learners within the organization, for example, by job title, or specific assignments. In addition a Learner may choose to work towards a higher classification, or may desire to qualify for a different type of job, or a specific position, so they may choose to meet other Requirements than just those assigned by their organization.

Embodiments of the invention may provide the information needed to determine which Requirements apply, in some cases even Learning and Testing Resources to assist in this important function. Then, embodiments of the invention may support each Learner having assigned and choosing the Requirements they must and strive to meet. For example, the MANDT behavioral system has nine different levels, depending on both the situations likely to be encountered, and their complexity; a Learner may be required to have a particular level, and a system embodying the invention may track whether they have attained it, and the corresponding courses needed. As a Learner moves from one assignment to another they may need to move to a higher level, and, thus, additional training may be requested. Similarly, for Abuse and Neglect, a supervisor may need substantial additional training, so if a Learner may be promoted to supervisor, they may need to take the additional training in the appropriate time frame. Also, assignments may affect the specifics of what training may be needed. Then, the Learner or Learning Organization may determine which of these Requirements have already been met, and which still may need to be achieved. Embodiments of the invention may support this by tracking the Learning Certificates already obtained by the Learner or Organization. Embodiments of the invention may also track what time period additional training needs to be completed. For example, a new employee may have 30 days or six months to complete various training Requirements. If they do not meet these Requirements in time, then they may not perform that job. Then, once they complete these Requirements, each certificate may expire in six, 12, or 24 months, so additional training may be required, typically not more than 30 or 90 days prior to expiring. If the Learner may not complete the training within the allowed time, they may not continue with that job. Further, if their certificate lapses, they may need to take additional training, beyond that which would have been required for recertification within the time period.

Based on factors such as the expiring certificate intervals or schedules for appropriate classes, embodiments of the invention may indicate the order for addressing the Requirements.

Once a Requirement or set of Requirements has been selected, embodiments of the invention may identify those Learning Resources which should be considered by the Learner or Organization. This recommendation may be based on many factors.

Related Learning Plans: a Learning organization may recommend, or even require specific Learning Resources. The organization may have already purchased access to specific Learning Resources and the Requirements may specify certain Learning Resources. For a Learning Organization, they may get recommendations from other organizations, for example, the State regulatory body, or a professional organization. Embodiments of the invention may comprise information about these recommendations and Requirements. The Learner may set values for the characteristics embodiments of the invention may track for each Learning Resource. Because embodiments of the invention may record so much information about each Learning Resource as more Learners use a system embodying the invention. The Learner or Organization may ask for information such as the statistical characteristics of Learning Resources appropriate to the set of Requirements, the average, maximum, and minimum values of Effectiveness in meeting the Requirement by Learners who use the Learning Resources.

As shown in FIG. 13, the Learning Resources, Testing Resources, Learning Certificates, Requirements and Goals, Related Learning Plans may be all evaluated to Identify Relevant Requirements and Constraints 1302.

Learning and Testing Resources 103 and 104 entered into a system embodying the invention may comprise resources identified by owners and also resources identified by other resources. Related Learning Plans 1301 may comprise resources by other Learners or Learning organizations. Algorithms exist to consider all these resources including Learning Certificates 108 and Requirements and Goals 102 in order to identify relevant Requirements and constraints.

The mechanism of the system next chooses a set of target Requirements and constraints. Based on the target Requirements and Learner characteristics 1306 embodiments of the invention may identify different resource choices 1304.

An integral part of optimization may be measures of the desirability of a particular alternative, such as the E-Cubed Ratings mentioned earlier—Effectiveness, Efficiency and Enjoyment, and embodiments of the invention may provide a combination of measures to balance the different aspects.

The number of choices and options in Learning Resources may make some form of assistance essential in selecting among them. For a particular requirement, or set of requirements, a system embodying the invention may identify Learning Resources which may be appropriate. This may be based on a variety of information, depending on what may be available: identified as appropriate or mandatory in the requirements, specified by the learning organization, recommended by a professional or other association, have been shown to be effective in use by other Learners or organizations, information from organizations which provide guidance on relevant resources (may comprise the owner of resources). A collection of Learning Resources may also be needed or preferred, so such a system may provide the ability to group resources either by specification or automatically identified by the system.

Such a system may provide data and algorithms to help in determining the effectiveness of different Learning Resources for each Learner or Learning organization. These may be based on several different methods.

Embodiments of the invention may also assist in determining the costs and resources requested for each of the alternative set of Learning Resources to meet the objectives. Each Learning Resource may be more or less enjoyable for the Learner or the Learning organization. An example of this may be preferences expressed explicitly by the Learner or Learning Organization for Learning Resource types such as comparisons between live classes, self-study, online interaction, books, audio material, video material and practical instruction. Resource types may also comprise schedules such as session duration or time of day and other resource types, for example, particular instructors or resource providers.

Another example of how a Learning Resource may be enjoyable for the Learner or Learning Organization may be preferences expressed implicitly by the Learner using the Evaluator Tools which may allow embodiments of the invention to determine the Learners' enjoyment of each Learning Resource they use.

Learning needs may be a complex function of previous accomplishments and experience as well as needs linked to corresponding Requirements. Learning needs may depend on the following factors, such as the Learner History, Learner Situations and Learner Interests. The Learner History may be used at many different levels of detail depending on the Requirements defined by the institution, courses, lessons and degrees. Learner situations often define which Requirements may need to be met. These may include Job Requirements, Professional Requirements, Academic Requirements, and other situations as they arise. Each Learner may have a different interest, for example, to earn a particular degree, or meet Job or Professional Requirements beyond the current situation and these may be termed as Learner Interests.

Embodiments of the invention may have Prediction Algorithms to assist Learner decision making on choice of curricula. The Learner's choice may be based on factors, such as available curricula, for example, choosing a school, career, or job. It may also be based on costs, for example, estimates of the costs to the Learner and others, such as employer or parents. Costs depend on many factors, comprising the employer, professional societies, scholarships available or student loan.

Other factors may be schedules which include the availability of courses and compatibility of schedules and other resources such as computers, books, and online resources which may be required for the Learner.

Embodiments of the invention may have algorithms that may predict the time that may be required for the Learner to complete the curricula, whether the Learner may be able to master the curricula, and the likelihood that the Learner may meet the desired Requirements. Another factor may be the likelihood of acceptance in the Plan selected where many curricula may be selective, so the Learner needs to determine whether to apply for a particular curriculum and what the Requirements may be to enter that curriculum.

Embodiments of the invention may have mechanisms to provide the Learner with the information and algorithms to evaluate alternatives to select a Learner Plan based on complex situations involving Requirements, availability, costs, resources, schedules, and Learner choices.

Embodiments of the invention may provide information for the Learner to balance the many complex inputs to establish their own Learner Plan and also provide algorithms to estimate the resources required by the Learner for different alternatives. Embodiments of the invention may allow the Learner to evaluate multiple alternatives and even optimize selections based on weighting and criteria supplied by the Learner in an iterative process. As the Learner makes broad decisions, and those may be accepted, then successively more detailed decisions may be evaluated and selected.

The Learning Plan may be a key to being able to relate resources to results, because it may allow localization of activities in relation to the desired and measured results. Using a resource at one time may affect an outcome at a much later time, but this correlation may be extremely difficult to establish causality, and, thus, the localization of learning by working through the Learner Plan may be an essential tool.

One of the preferred embodiments of this invention may be collecting data across many different Learners. This allows identifying patterns, creating Predictive Models, evaluating and refining these models to continually improve the Optimal Learning Process. The details of the Learner History may be a key to this overall Optimal Learning Process.

Part of accomplishing this modeling, evaluation, and prediction, may be providing a set of utilities so that Learners and other users, such as Learning Organization Planners and Resource Managers, may analyze information, formulate and evaluate hypotheses, and improve all aspects of the learning process.

The utilities may comprise tools for evaluation of Effectiveness, Efficiency and Enjoyment, that may be, Learner Ratings and combinations of these measures to establish single valued measures for overall optimization. The basics of the evaluation tools comprise setting a minimum or maximum threshold for each value to be considered, for instance, a reading level no greater than eighth-grade. It may also involve creating a weighted sum of values as well as establishing required characteristics, such as the inclusion of color graphics. Evaluations may be done on a single resource or combine on a group of resources and generally, evaluations may be done in relation to a set of Requirements and Goals.

A set of all these evaluation tools may be combined into a single function and the function may then be used repetitively by the owner and also passed on to others as part of a Learning Plan for their use in Evaluation, or even turn into a resource itself.

A system embodying the invention may predict how long it may take a Learner to process the resource, and the expected Effectiveness, Efficiency, and Enjoyment the Learner may experience with that resource.

The actions and results of each Learner may be made available at a variety of different levels of detail, using specified algorithms for summarizing, combining, modeling and securing the data. Examples of actions and results that may need to be made available could be that a Learning Objective has been achieved, based on a minimum score on a specified test plus a practical examination by a Certified Instructor.

Another example may be for investigation of specific events—the answers to specific test questions and the detailed content of lessons may be essential to show that an organization or an Individual exercised appropriate care in that event. A Learner's “transcript” may be another instance which may summarize the courses taken and the results, and the remaining time before recertification as well as the time and other resources applied to a Learning Plan or component of the Plan

The proportion of Learners who achieved a particular certification after using a particular Learning Resource as well as the proportion of Learners in an organization, who achieved overall certification within the specified time interval, may be further examples of actions and results that may need to be made available.

The present invention is not limited to the above-mentioned embodiments and various modifications may be considered without departing from the technical concept of the present invention.

We claim:

1. A system for gathering, organizing, and managing information relating to learning processes comprising:
a means for gathering an individual's learning information;
a means for organizing said learning information;
a means for updating said learning information;
a means for monitoring said learning information;
a means for storing said learning information;
a means for providing authorized users with access to said learning information;
a means for gathering learning requirements;
a means for updating said learning requirements;
a means for monitoring said learning requirements;
a means for storing said learning requirements;
a means for providing authorized users with access to said learning requirements;
a means for gathering learning resources;
a means for updating said learning resources;
a means for monitoring said learning resources;
a means for storing said learning resources;
a means for providing authorized users with access to said learning resources;
a means for gathering testing resources;
a means for updating testing resources;
a means for monitoring testing resources;
a means for storing testing resources;
a means for providing authorized users with access to said testing resources;
a means for cross referencing said learning information, said learning requirements, said learning resources and testing resources; and
a means for providing authorized users with the results of said cross referencing.

2. The system of claim 1 wherein said learning information comprises learning activities.

3. The system of claim 1 wherein said learning requirements is imposed by regulation.

4. The system of claim 3 wherein said regulations is national regulations.

5. The system of claim 3, wherein said regulations is State regulations.

6. The system of claim 1 wherein said learning requirements is imposed by a governing organization.

7. The system of claim 1 wherein said learning requirements is imposed by a governing association.

8. The system of claim 1 wherein said learning requirements is imposed by a governing institution.

9. The system of claim 1 wherein said learning requirements is imposed by said individual.

10. The system of claim 1 wherein said means for providing authorized users with access to said testing resources comprises a system using Caseloads.

11. The system of claim 1 wherein said means for updating said learning requirements accounts for temporal characteristics of said learning requirements

12. The system of claim 11 wherein said temporal characteristics comprise certification renewal grace periods.

13. The system of claim 11 wherein said temporal characteristics comprise at least one rule change.

14. The system of claim 1 wherein said learning Information is used by direct support professionals;

15. The system of claim 1 wherein said learning requirements is used by direct support professionals;

16. The system of claim 1 wherein said learning resources is used by direct support professionals;

17. The system of claim 1 wherein said testing resources is used by direct support professionals;

18. The system of claim 1 wherein said individual is a direct support professional;

19. The system of claim 1 wherein said learning requirements is imposed for direct support professionals.

20. A computerized method of gathering, organizing and managing information relating to learning processes, comprising:
gathering an individual's learning information;
organizing said learning information;
updating said learning information;
monitoring said learning information;
storing said learning information;
providing authorized users with access to said learning information;
gathering learning requirements;
updating said learning requirements;
monitoring said learning requirements;
storing said learning requirements;
providing authorized users with access to said learning requirements;
gathering learning resources;
updating said learning resources;
monitoring said learning resources;
storing said learning resources;
providing authorized users with access to said learning resources;
gathering testing resources;
Updating testing resources;
monitoring testing resources;
storing testing resources;
providing authorized users with access to said testing resources;
cross referencing said learning information, said learning requirements, said learning resources and testing resources;
providing authorized users with the results of said cross referencing.

21. The method of claim 20 wherein said learning information comprises learning activities.

22. The method of claim 20 wherein said learning requirements is imposed by regulation.

23. The method of claim 22 wherein said regulations is national regulations.

24. The method of claim 22, wherein said regulations is State regulations.

25. The method of claim 20 wherein said learning requirements is imposed by a governing organization.

26. The method of claim 20 wherein said learning requirements is imposed by a governing association.

27. The method of claim 20 wherein said learning requirements is imposed by a governing institution.

28. The method of claim 20 wherein said learning requirements is imposed by said individual.

29. The method of claim 20 wherein said providing authorized users with access to said testing resources comprises using Caseloads.

30. The method of claim 20 wherein said updating said learning requirements accounts for temporal characteristics of said learning requirements

31. The method of claim 30 wherein said temporal characteristics comprise certification renewal grace periods.

32. The method of claim 30 wherein said temporal characteristics comprise at least one rule change.

33. The method of claim 20 wherein said learning Information is used by direct support professionals;

34. The method of claim 20 wherein said learning requirements is used by direct support professionals;

35. The method of claim 20 wherein said learning resources is used by direct support professionals;

36. The method of claim 20 wherein said testing resources is used by direct support professionals;

37. The method of claim 20 wherein said individual is a direct support professional;

38. The method of claim 20 wherein said learning requirements is imposed for direct support professionals.

39. A system for gathering, organizing, and managing information relating to learning processes comprising:
a computer;
a computer program for gathering an individual's learning information;
a computer program for organizing said learning information;
a computer program for updating said learning information;
a computer program for monitoring said learning information;
a computer program for storing said learning information;
a computer program for providing authorized users with access to said learning information;
a computer program for gathering learning requirements;
a computer program for updating said learning requirements;
a computer program for monitoring said learning requirements;
a computer program for storing said learning requirements;
a computer program for providing authorized users with access to said learning requirements;
a computer program for gathering learning resources;
a computer program for updating said learning resources;
a computer program for monitoring said learning resources;
a computer program for storing said learning resources;
a computer program for providing authorized users with access to said learning resources;
a computer program for gathering testing resources;
a computer program for updating testing resources;
a computer program for monitoring testing resources;
a computer program for storing testing resources;
a computer program for providing authorized users with access to said testing resources;
a computer program for cross referencing said learning information, said learning requirements, said learning resources and testing resources;
a computer program for providing authorized users with the results of said cross referencing.

40. The system of claim 39 wherein said learning information comprises learning activities.

41. The system of claim 39 wherein said learning requirements is imposed by regulation.

42. The system of claim 41 wherein said regulations is national regulations.

43. The system of claim 41, wherein said regulations is State regulations.

44. The system of claim 39 wherein said learning requirements is imposed by a governing organization.

45. The system of claim 39 wherein said learning requirements is imposed by a governing association.

46. The system of claim 39 wherein said learning requirements is imposed by a governing institution.

47. The system of claim 39 wherein said learning requirements is imposed by said individual.

48. The system of claim 39 wherein said means for providing authorized users with access to said testing resources comprises a system using Caseloads.

49. The system of claim 1 wherein said means for updating said learning requirements accounts for temporal characteristics of said learning requirements

50. The system of claim 49 wherein said temporal characteristics comprise certification renewal grace periods.

51. The system of claim 49 wherein said temporal characteristics comprise at least one rule change.

52. The system of claim 39 wherein said learning Information is used by direct support professionals;

53. The system of claim 39 wherein said learning requirements is used by direct support professionals;

54. The system of claim 39 wherein said learning resources is used by direct support professionals;

55. The system of claim 39 wherein said testing resources is used by direct support professionals;

56. The system of claim 39 wherein said individual is a direct support professional;

57. The system of claim 39 wherein said learning requirements is imposed for direct support professionals.
